(19) United States
(12) Patent Application Publication
(10) Pub. No.: US 2023/0291188 A1
(43) Pub. Date: Sep. 14, 2023

(54) CABLE TRAY SPLICE PLATE ASSEMBLY

(71) Applicant: Eaton Intelligent Power Limited, Dublin (IE)

(72) Inventors: Amol Khalkar, Nasik (IN); Nimesh Shah, Nagpur (IN); Eshant Bhalerao, Deulgaon Raja (IN); Hemraj Keda Thorat, Pune (IN); Ramesh N. Birje, Pune (IN); Jacob Lee Johnson, New Baden, IL (US); Martin Lee Witherbee, Godfrey, IL (US)

(73) Assignee: Eaton Intelligent Power Limited, Dublin (IE)

(21) Appl. No.: 18/180,699

(22) Filed: Mar. 8, 2023

Related U.S. Application Data
(60) Provisional application No. 63/318,133, filed on Mar. 9, 2022.

(51) Int. Cl. H02G 3/06; H02G 3/04; F16B 7/04; F16L 3/26

(52) U.S. Cl. CPC H02G 3/0608; F16B 7/0433; F16L 3/26; H02G 3/0456

(57) ABSTRACT

The present disclosure provides a splice plate including a planar body, first and second pairs of opposing side walls, and a pair of tabs. The first pair of opposing side walls define two parallel slots with one slot engaging a first wire of a first cable tray section and a second slot engaging a first wire of a second cable tray section. The second pair of opposing side walls define at least one slot. A side wall of one of the second pair of opposing side walls engages a second wire of the first cable tray. A side wall of the other of the second pair of opposing side walls engages a second wire of the second cable tray section. One tab of the pair of tabs engages the first wire of the first cable tray section and a second tab engages the second cable tray section’s first wire.

### CROSS-REFERENCE TO RELATED APPLICATION

This application claims the benefit of U.S. Provisional Application No. 63/318,133, filed, Mar. 9, 2022, the entirety of which is hereby incorporated by reference.

### FIELD OF THE DISCLOSURE

The present disclosure relates to a cable tray splice plate assembly to splice together multiple wire basket cable tray sections.

### BACKGROUND

Cable support systems featuring trays are known for supporting a network of cables below raised floors or above hung ceilings and in other areas where cable networks are located. The conventional cable tray system is made up of a large number of trays positioned end to end along a desired route where cables are to be placed and supported. The cable trays, in turn, are supported by a number of brackets or hangers mounted on support shafts (such as sub-floor support shafts holding up a raised floor), walls, ceilings, floors or other building structures. The trays are connected to each other by clips or clamps. One type of cable tray is a wire basket cable tray. The wire basket cable tray comprises a plurality of spaced apart longitudinal wires secured (e.g., welded) to a plurality of spaced apart transverse wires. Cable tray sections are spliced together using splice plates to form a cable tray assembly.

### BRIEF SUMMARY

In one aspect, the present disclosure provides a splice plate for connecting two adjacent wire basket cable trays. The splice plate comprises a planar body, a first pair of opposing side walls, a second pair of opposing side walls, and a pair of tabs. The first and second pairs of opposing side walls extend from the planar body. The first pair of opposing side walls define at least two parallel slots. A first slot of the two parallel slots is configured to engage a first wire of a first cable tray section and a second slot of the two parallel slots is configured to engage a first wire of a second cable tray section parallel to the first wire of a first cable tray. The second pair of opposing side walls define at least one slot. A side wall of one of the second pair of opposing side walls being configured to engage a second wire of the first cable tray section transverse to the first wire of the first cable tray section. A side wall of the other of the second pair of opposing side walls is configured to engage a second wire of the second cable tray section aligned with the second wire of the first cable tray and transverse to the first wire of the second cable tray section. The pair of tabs extend toward a central axis of the planar body. One of said pair of the tabs is configured to engage the first wire of the first cable tray section, and the other of said pair of tabs configured to engage the first wire of the second cable tray section.

In another aspect, the disclosure provides a splice plate assembly for connecting two adjacent wire basket cable trays. The splice plate assembly comprises an inner part and an outer part. The inner part comprises a planar body and a side wall. The side wall extends transversely from the planar body and terminates in an outwardly extending tab. The outer part comprises a planar body, first and second side walls, and at least two slots. The first and second side walls extend downward from the planar body away from the inner part. The at least two slots are defined by the planar body. Each of the slots have a wider portion configured to allow insertion of the side wall of the inner part and a narrower portion configured to lock the inner part into the outer part by preventing passage of the tab of the side wall of the inner part.

In another aspect, the disclosure provides another splice plate assembly for connecting two adjacent wire basket cable trays. The splice plate assembly comprises a planar body, an inboard wall downwardly extending from the planar body, and an outboard wall downwardly extending from the planar body. The outboard wall comprises two extension tabs and a central tab between the two extension tabs and spaced apart by a slot. Each slot is configured to receive a separate transverse wire of adjacent cable tray sections. The extension tabs and central tab each comprise a catch being configured to receive at least one longitudinal wire.

In another aspect, the disclosure provides yet another splice plate assembly for connecting two adjacent wire basket cable trays. The splice plate assembly comprises a main body, a transition portion, and an interlocking wedge. The main body comprises an upper channel section and at least one lower channel section extending from the upper channel section. The transition portion from the upper channel section and lower channel section defines an elongated slot. The interlocking wedge is received in the elongated slot and configured to rotate in the elongated slot to a locked position.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a perspective view of a wire basket cable tray sections spliced together by splice plate assemblies described herein;

FIG. 2 is a perspective view of a splice plate according to one embodiment of the present disclosure;

FIG. 3 is a front plan view of the splice plate of FIG. 2;

FIG. 4 is a cross sectional view taken through line 4—4 of FIG. 5;

FIG. 5 is a top plan view of the splice plate of FIG. 2;

FIG. 6 is a bottom plan view of the splice plate of FIG. 2;

FIG. 7 is a perspective view of the splice plate of FIG. 2 used in a cable tray assembly splicing two wire basket cable tray sections together;

FIG. 8 is an enlarged fragmentary view of upward extending tabs of the splice plate of FIG. 2 engaging the cable tray wires;

FIG. 9 is a perspective view of another embodiment of a splice plate splicing two wire basket cable tray sections together;

FIG. 10 is a perspective view of the splice plate used in FIG. 9;

FIG. 11 is a side plan view of the splice plate of FIG. 10;

FIG. 12 is a front plan view of the splice plate of FIG. 10;

FIG. 13 is a perspective view of another embodiment of a splice plate splicing two wire basket cable tray sections together;

FIG. 14 is a perspective view of the splice plate used in FIG. 13;

FIG. 15 is a perspective view of another splice plate assembly of the present disclosure;

FIG. 16 is a top plan view of the splice plate of FIG. 15;

FIG. 17 is a cross sectional front view of the splice plate of FIG. 15;

FIG. 18 is side plan view of the splice plate of FIG. 15;

FIG. 19 is a perspective view of another embodiment of a splice plate splicing two wire basket cable tray sections together;

FIG. 20 is a perspective view of the splice plate assembly of FIG. 19;

FIG. 21 is a perspective view of a main body of the splice plate assembly of FIG. 20;

FIG. 22 is a front plan view of the main body of the splice plate assembly of FIG. 20;

FIG. 23 is a front plan view of an interlocking wedge of the splice plate assembly of FIG. 20;

FIG. 24 is a perspective view of another embodiment of a splice plate splicing two wire basket cable tray sections together;

FIG. 25 is a perspective view of another embodiment of a splice plate splicing two wire basket cable tray sections together;

FIG. 26 is a perspective view of other embodiments of a splice plate splicing two wire basket cable tray sections together;

FIG. 27 is another perspective view of the splice plate in FIG. 26 splicing two wire basket cable tray sections together;

FIG. 28 is an enlarged top view of the splice plate of FIG. 25 splicing two wire basket cable tray sections together;

FIG. 29 is a perspective view of the splice plate of FIG. 28;

FIG. 30 is a top view of the splice plate of FIG. 28;

FIG. 31 is a perspective view of an inner part of the splice plate of FIG. 28;

FIG. 32 is a perspective view of an outer part of the splice plate of FIG. 28;

FIG. 33 is a perspective view of a splice plate of FIGS. 26-27 splicing two wire basket cable tray sections together;

FIG. 34 is a perspective view of the splice plate of FIG. 33;

FIG. 35 is a top view of the splice plate of FIG. 34;

FIG. 36 is a perspective view of an inner part of the splice plate of FIG. 34;

FIG. 37 is a perspective view of an outer part of the splice plate of FIG. 34;

FIG. 38 is a perspective view of another splice plate of FIGS. 26-27 splicing two wire basket cable tray sections together;

FIG. 39 is a perspective view of the splice plate of FIG. 38;

FIG. 40 is a top view of the splice plate of FIG. 39;

FIG. 41 is a perspective view of an inner part of the splice plate of FIG. 39;

FIG. 42 is a perspective view of an outer part of the splice plate of FIG. 39;

FIG. 43 is a perspective view of another splice plate of FIGS. 26-27 splicing two wire basket cable tray sections together;

FIG. 44 is a perspective view of the splice plate of FIG. 43;

FIG. 45 is a top view of the splice plate of FIG. 44;

FIG. 46 is a perspective view of an inner part of the splice plate of FIG. 44;

FIG. 47 is a perspective view of an outer part of the splice plate of FIG. 44;

FIG. 48 is a perspective view of another splice plate of FIGS. 26-27 splicing two wire basket cable tray sections together;

FIG. 49 is a perspective view of the splice plate of FIG. 48;

FIG. 50 is a top view of the splice plate of FIG. 49;

FIG. 51 is a perspective view of an inner part of the splice plate of FIG. 49;

FIG. 52 is a perspective view of an outer part of the splice plate of FIG. 49;

FIG. 53 is a perspective view of another splice plate of FIGS. 26-27 splicing two wire basket cable tray sections together;

FIG. 54 is the perspective view of FIG. 53 with a divider post removed;

FIG. 55 is a perspective view of the splice plate of FIG. 54;

FIG. 56 is a top view of the splice plate of FIG. 55;

FIG. 57 is a perspective view of an inner part of the splice plate of FIG. 55; and

FIG. 58 is a perspective view of an outer part of the splice plate of FIG. 55.

Corresponding reference characters indicate corresponding parts throughout the drawings.

### DETAILED DESCRIPTION

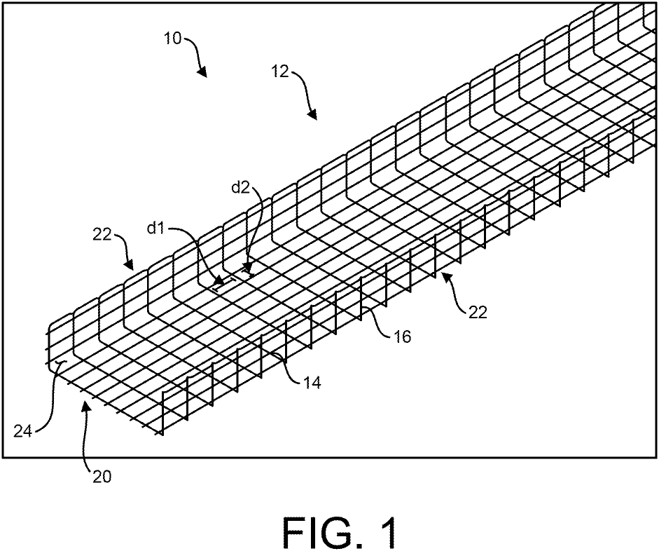

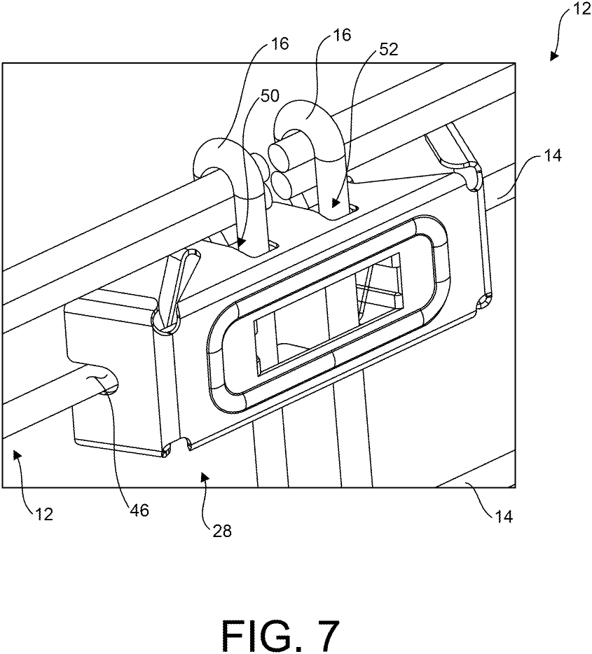

Referring to FIG. 1, a wire basket cable tray assembly 10 includes a least one cable tray section 12. Cable tray section 12 includes a plurality of longitudinal wires 14 extending along a length of the cable tray, and a plurality of transverse wires 16 secured to the longitudinal wires and extending generally transverse to the longitudinal wires. In the illustrated embodiment, the transverse wires 16 are secured on upper portions of the longitudinal wires 14, although the transverse wires may be secured to the lower portions of the longitudinal wires in other embodiments or the wires may be interlaced by weaving. The assembly of the wires 14, 16 forms a floor, generally indicated at 20, and opposing side walls of the tray, generally indicated at 22. Adjacent longitudinal wires 14 are parallel to and spaced apart from one another in the transverse direction, and adjacent transverse wires 16 are parallel to and spaced apart from one another in the longitudinal direction so as to form rectangular tray openings 24. Each tray opening 24 has a longitudinal dimension d1 measured between adjacent transverse wires 16, and a transverse dimension d2 measured between adjacent longitudinal wires 14. These tray openings 24 may be generally uniform, at least at the floor 20 of the cable tray 12. Cable tray sections 12 are spliced together with a splice plate assembly 28 (FIG. 7). As used herein, terms denoting relative locations and positions of components, including but not limited to “upper,” “lower,” “left,” “right,” “front,” “back,” and “rear” are in reference to the cable tray assembly 10 in the horizontal direction, as shown in FIG. 1. It is understood that the cable tray assembly 10 may be in a vertical orientation in the field, whereby the relative locations and positions of the components and structures would be different than as shown in the drawings. As used herein, the term “inboard” means toward or in the interior of the cable tray section 12 and/or cable tray assembly 10. As used herein, the term “outboard” means away from the interior or at the exterior of the cable tray section 12 and/or cable tray assembly 10.

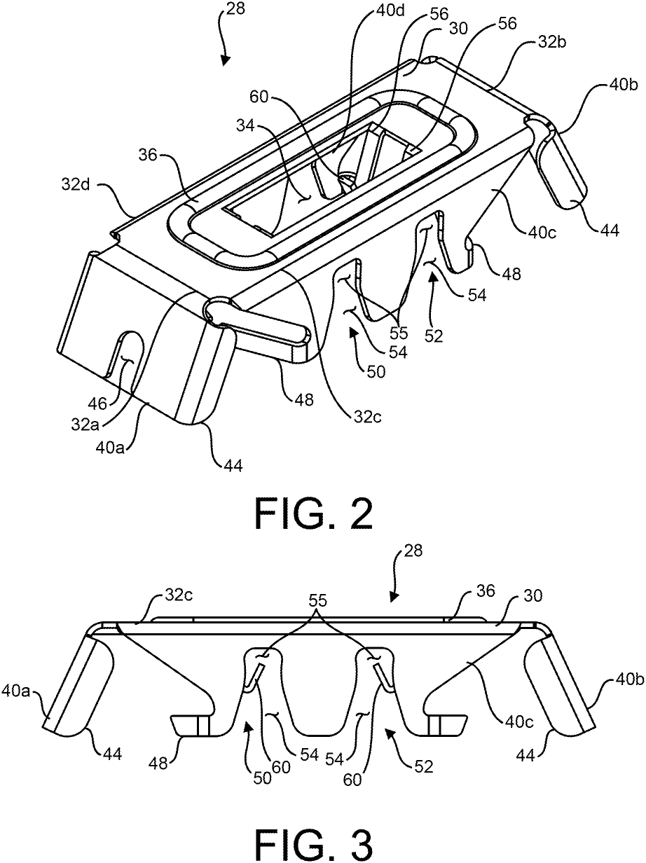

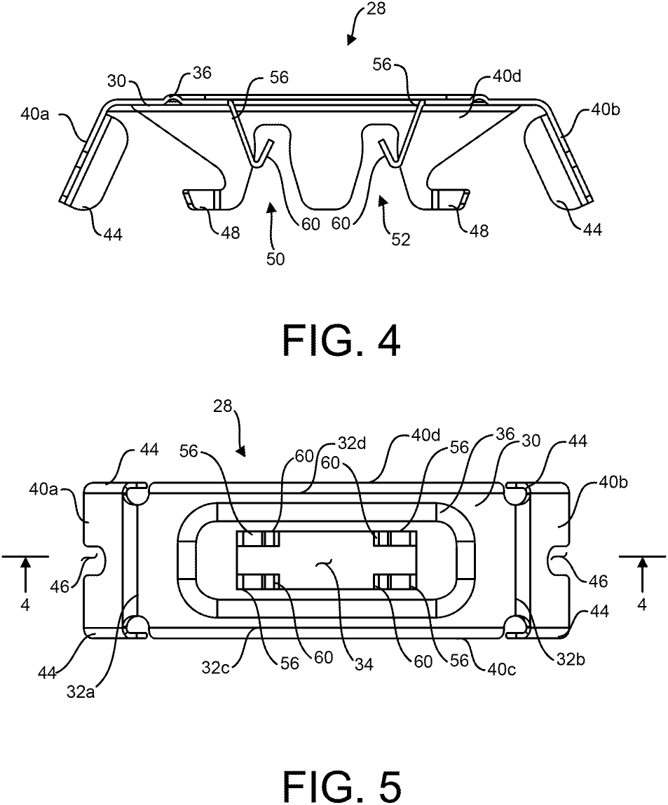

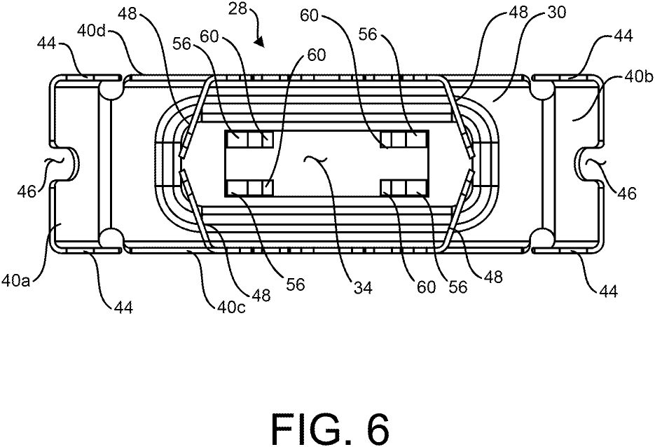

Referring in particular to FIGS. 2 to 8, the splice plate assembly according to one embodiment of the present disclosure is generally indicated at reference numeral 28. The splice plate assembly 28 generally comprises a generally planar main body portion 30 having left, right, front, and back edges 32a, 32b, 32c, 32d. In the illustrated embodiment, the main body portion 30 is rectangular such that the length of the left and right edges 32a, 32b is less than the length of the front and back edges 32c, 32d, although any other suitable shape can be used. The main body portion 30 defines an opening 34 thereon that provides flexing ability to the splice plate 28. In some embodiments, opening 34 is an elongated slot. Located on the main body portion 30 outside of the opening 34 is a strengthening rib 36. The strengthening rib 36 provides an elevated height to the main body portion 30 above the perimeter walls defining opening 34. In this way, any wires that may pass over the splice plate assembly 28 engage the rib 36 and have reduced contact or no contact with the opening 34.

The left and right edges 32a, 32b of the main body portion 30 terminate in left and right side walls 40a, 40b. Left and right side walls 40a, 40b are generally angled with respect to the longitudinal plane of the main body portion 30. For example, the left and right side walls 40a, 40b can form an angle from about 20 degrees to about 80 degrees, and preferably less than 90 degrees. In preferred embodiments, the angle is from about 30 degrees to about 60 degrees. The left and right side walls 40a, 40b contain a tab 44 on either side thereof that is perpendicular to the side walls 40a, 40b. The left and right side walls 40a, 40b also define a slot 46 thereon in a central portion thereof.

The front and back edges 32c, 32d of the main body portion 30 terminate in front and back side walls 40c, 40d. Front and back side walls 40c, 40d are generally perpendicular to the main body portion 30. The front and back side walls 40a, 40b have angled edges that are angled from about 20 degrees to about 80 degrees with respect to a longitudinal plane of the main body portion 30. In the illustrated embodiment, the front and back side walls 40c, 40d are not coupled to or in contact with the left and right side walls 40a, 40b. Thus, while each of tabs 42 extend toward the front and back side walls 40c, 40d, they are not coupled to side walls 40c, 40d. This lack of contact is facilitated by both the angle of the left and right side walls 40a, 40b as well as the angled edges of the front and back side walls 40a, 40b.

The side edges of the front and back side walls 40c, 40d terminate in a locking tab 48. The locking tab 48 extends both towards the other of the front or back side wall 40a, 40b as well as the nearest of the left and right side walls 40a, 40b. Thus, each of the locking tabs extend at an angle with respect to a transverse axis of the main body portion 30 of from about 20 degrees to about 80 degrees. The locking tab prevents pop out of any wire inserted therein by exerting pressure on the wire

The front and back side walls 40c, 40d each define two slots 50, 52 thereon. Each of the slots 50, 52 have a bottom portion 54 nearest the bottom edge of the front and back side walls 40c, 40d and a top portion 55 nearest the top edge of the front and back side walls 40c, 40d. The bottom portion 54 of the slot 50, 52 generally has side walls that angle inward, while the top portion 55 of the slot 50, 52 has a dove-tail shape.

Coupled to the perimeter wall of the opening 34 is at least one downwardly extending arm 56. Typically, the arm 56 is coupled to one of the left or right sides of the perimeter wall of the opening 34. In the illustrated embodiment, each of the left and right sides of the perimeter wall of the opening 34 contains two downwardly extending arms 56 at the top and bottom edges thereof. Typically, the arm 56 extends downward at an angle relative to the longitudinal plane of the main body portion 30. For example, the angle can be from about 30 degrees to about 90 degrees. Each arm 56 terminates in an upwardly extending tab 60. The upwardly extending tab extends upward at an angle relative to the plane of the arm 56. For example, the angle can be from about 30 degrees to about 90 degrees, more particularly, from about 30 degrees to about 60 degrees.

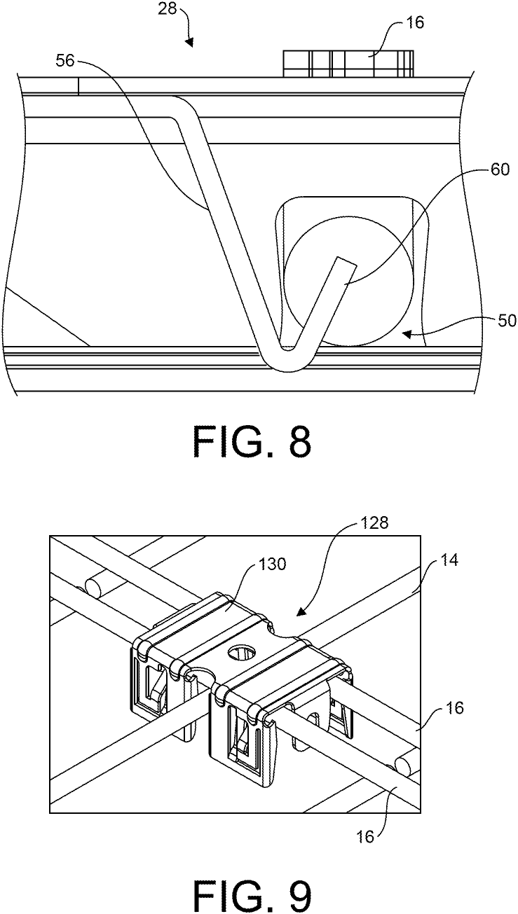

Splice plate assembly 28 can be installed on the base or sides of the cable tray assembly 10. During installation, the splice 28 is snapped onto a cable tray such that transverse wires 16 from two adjacent cable tray sections are received within slots 50, 52, whereas the longitudinal wires 14 are received within slots 46. The upwardly extending tab 60 exerts pressure on the transverse wires to preserve electrical continuity (FIG. 8).

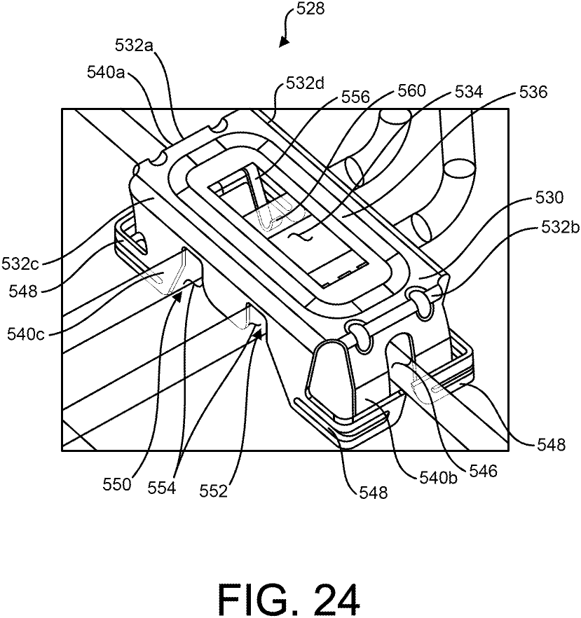

The splice plate assembly 528 (FIG. 24) is similar to splice plate assembly 28 and similar features are indicated by the same reference numeral plus 500. The splice plate assembly 528 includes a different type of locking tab 548. In contrast to locking tab 48, locking tab 548 extends in the same plane as the front and back side walls 540c, 540d to the nearest of the left or right side walls 540a, 540b. The locking tab 548 extends toward and into the slot 546, such that each locking tab 548 on either side of slot 546 must be deflected in order to insert a wire therein. In other embodiments, locking tab 548 extends in any other appropriate manner toward and into the slot 546 to allow for retaining of any wire inserted therein. The skilled person will understand that the longer locking tab 548 extends, the more flexible the tab will be.

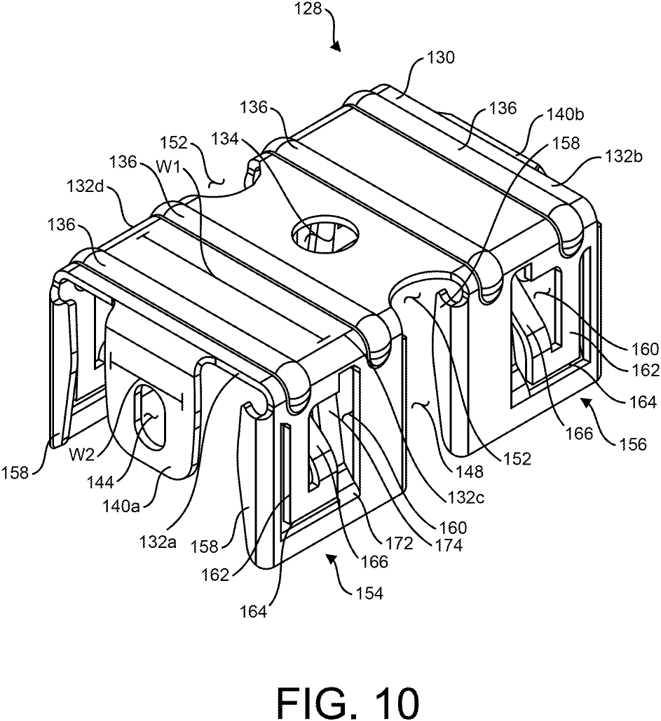

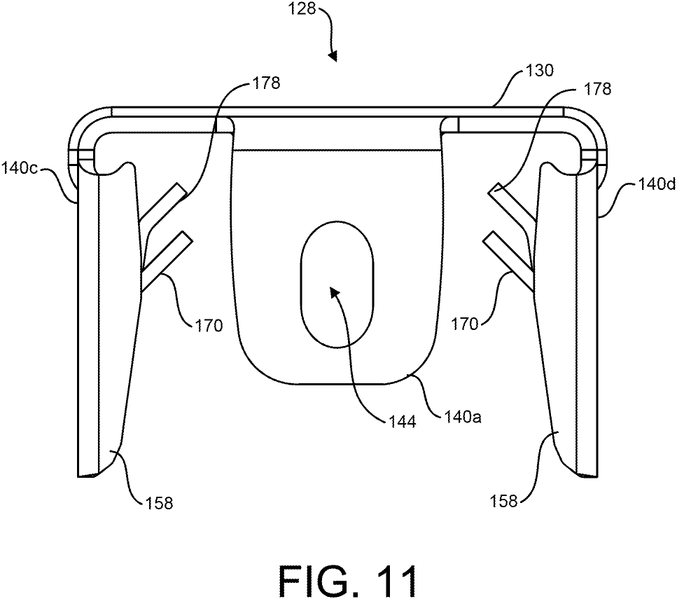

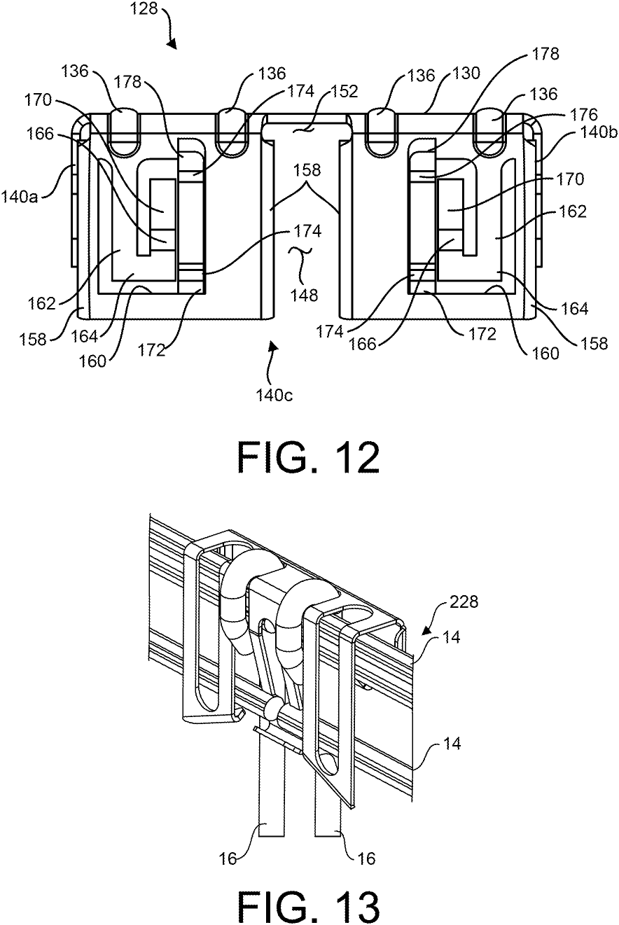

Turning now to FIGS. 9 to 11, another embodiment of the splice plate assembly of the present disclosure is generally indicated at reference numeral 128. The splice plate assembly 128 generally comprises a generally planar main body portion 130 having left, right, front, and back edges 132a, 132b, 132c, 132d. In the illustrated embodiment, the main body portion 130 is rectangular such that the length of the left and right edges 132a, 132b is less than the length of the front and back edges 132c, 132d, although any other suitable shape can be used. The main body portion 130 defines an opening 134 in a central portion of the main boy portion 30. In the illustrated embodiment, the opening is a fastener opening for insertion of a bolt to aid in installation and modularity. However, the opening 134 can also be a slot or any other suitable shape. The main body portion 130 contains transverse ribs 136 from the front edge to the back edge 132c, 132d. The ribs 136 provide increased strength as well as an elevated height to the main body portion 130 above the perimeter walls defining opening 134. In this way, any wires that may pass over the splice plate assembly 128 engage the ribs 136 and have reduced contact or no contact with the opening 134 or any fastener inserted therethrough.

The left and right edges 132a, 132b of the main body portion 130 terminate in downwardly extending tabs 140a, 140b that are generally perpendicular to the main body portion 130. The width w1 of the main body portion 130 is generally greater than the width w2 of the tabs 140a, 140b. The tabs 140a, 140b define an opening 144 thereon. The opening 144 can, in some embodiments, be an elongated slot. The tabs 140a, 140b are configured to hold the compressive load of the spliced cable tray sections.

The front and back edges 132c, 132d of the main body portion 130 terminate in front and back side walls 140c, 140d. Front and back side walls 140c, 140d are generally perpendicular to the main body portion 130. In various embodiments, strengthening ribs 136 may extend onto the front and back side walls 140c, 140d.

The front and back side walls 140c, 140d define a slot 148 thereon. The slot 148 can extend up a portion of the respective front or back side wall 140c, 140d, and in some embodiments, may extend onto the main body portion 130. For example, the slot 148 can terminate in a semi-circular cut-out 152 (or any other suitable shape) on the main body portion 130. In this way, each of the front and back side walls 140c, 140d have a first portion 154 and a second portion 156, the second portion 156 being a mirrored version of the first portion 154. The first and second portions 154, 156 have inwardly extending flanges 158 on both side walls. Each of the first and second portions 154, 156 define a central opening 160 thereon.

An arm 162 extends from a top edge of the opening 160 downward and terminates in a first wall 164 that is perpendicular to the arm 162 and planar with the top or bottom side wall 140c, 140d. The arm 162 is located to one side of the opening 160 farthest from the slot 148. The first wall 164 terminates in an extension arm 166 on an upper edge of the first wall 164 that can be curved (or angled with respect to the first wall 164) and extend inward into the splice plate assembly 128. The extension arm 166 terminates an in inwardly extending tab 170. The tab is angled from about 20 degrees to about 80 degrees with respect to the plane of the front or back side wall 140c, 140d.

Extending from the bottom edge of opening 160 nearest the slot 148 is an upwardly and inwardly extending first curved portion 172. The first curved portion 172 terminates in an upwardly and inwardly angled first leg portion 174. The first leg portion 174 is angled from about 10 degrees to about 50 degrees with respect to the plane of the respective top or bottom side wall 140c, 140d. The first leg portion 174 terminates in an upwardly and inwardly extending second curved portion 176, which then terminates in an upwardly and inwardly extending second leg portion 178. The second leg portion 178 is angled from about 10 degrees to about 50 degrees with respect to the plane of the respective front or back side wall 140c, 140d, and typically is generally about the same angle as the tab 170. While the second leg portion 178 and the tab 170 are roughly the same angle and parallel, the second leg portion 178 is situated inside of and above (by virtue of the first leg portion 174) the tab 170.

Generally, during installation, a longitudinal wire 14 is inserted through the slot 148, whereas two transverse wires 16 of adj acent cable tray sections are inserted on either side of tabs 140a, 140b. The second leg portion 178 is configured to provide pressure and electrical continuity to these transverse wires, whereas the tab 170 prevents unintentional pop-out of wires.

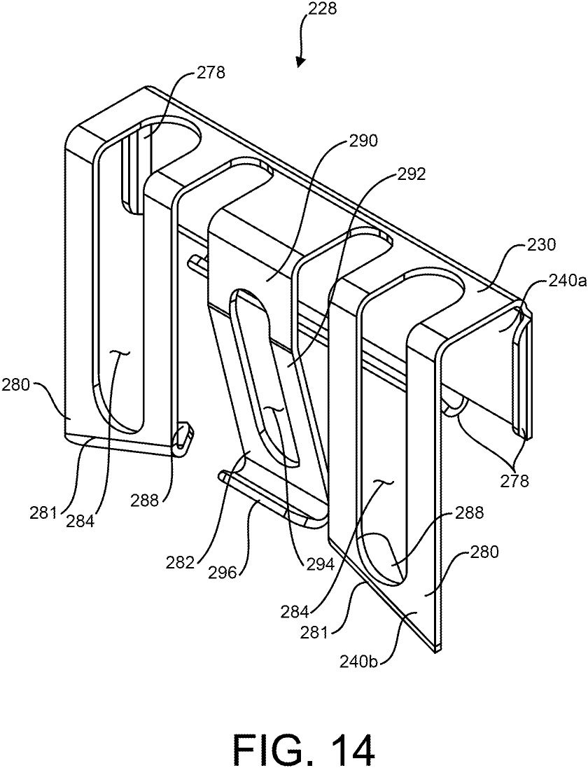

Turning now to FIGS. 13 and 14, another embodiment of the splice plate assembly of the present disclosure is generally indicated at reference numeral 228. Unlike the heretofore described splice plates, the splice plate 228 is configured to be installed on the top of the side walls of the cable tray, as illustrated in FIG. 13. The splice plate 228 generally comprises a top main body portion 230 with downwardly extending inboard and outboard side walls 240a, 240b that extend generally perpendicular to the main body portion 230. The inboard side wall 240a is generally planar with tabs 278 extending inward toward the main body portion 230 from each of the three free edges (e.g., left, right, and bottom edges). The tabs 278 prevent contact of the wires with any sharp edges.

The outboard side wall 240b comprises two extension tabs 280 on either side of a central tab 282. The extension tabs are generally perpendicular to the main body portion 230. Generally, the bottom edge 281 of the extension tabs 280 are upwardly angled toward the central tab 282. The extension tabs 280 contain an elongated opening 284 (e.g., slot) thereon that, in some embodiments, extends onto the main body portion 230. These openings 284 reduce the installation force of the splice 228. The angled bottom edge 281 is coupled to an inwardly extending catch 288.

The central tab 282 has a first portion 290 coupled to the main body portion 230 that is generally perpendicular to the main body portion 230. A second portion 292 is inwardly angled (i.e., in the inboard direction) from about 10 degrees to about 60 degrees with respect to the first portion 290. The second portion 292 of the central tab 282 defines an elongated opening 294 thereon. In some embodiments, the elongated opening 294 extends onto the first portion 290 of the central tab 282. The free end of the second portion 292 of the central tab 282 (i.e., the end not coupled to the first portion 290) terminates in an outwardly extending catch 296.

During installation, transverse wires of adjacent cable tray sections are received in openings on either side of the central tab 282. The outwardly extending catch 296 and inwardly extending catches 288 engage the longitudinal wires of the cable tray and lock the splice 228 in place.

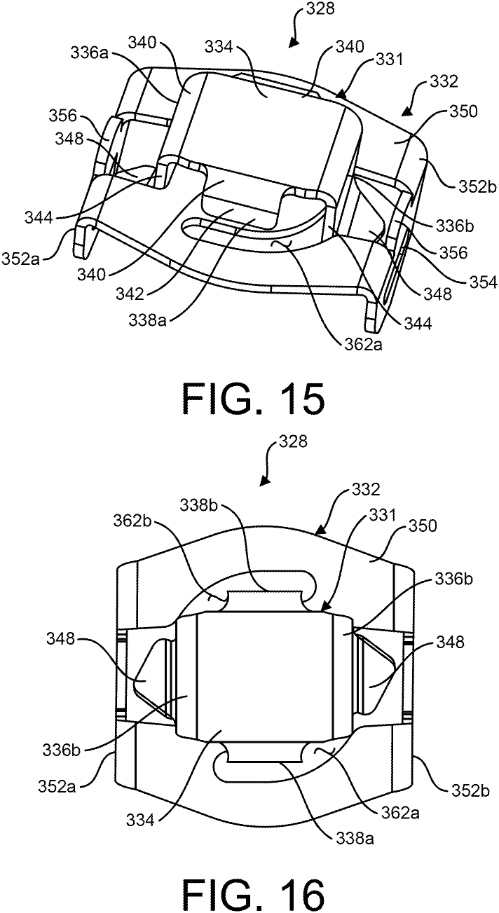

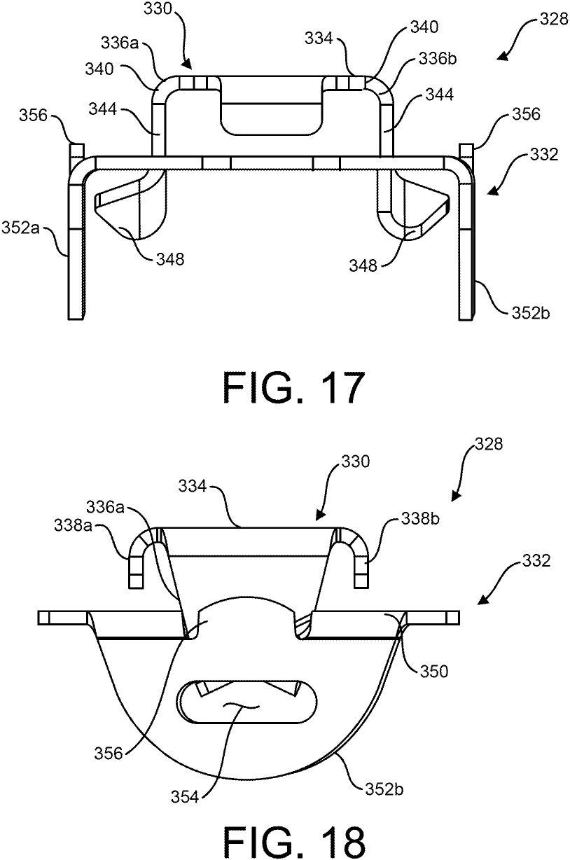

Turning now to FIGS. 15 to 18, another embodiment of the splice plate assembly of the present disclosure is generally indicated at reference numeral 328. The splice plate assembly 328 generally comprises an inner part 331 and an outer part 332, the inner and outer parts 331, 332 interconnecting after installation.

The inner part 331 comprises a generally planar body 334 with front and back downwardly extending arms 336a, 336b and left and right downwardly extending arms 338a, 338b from each of the edges of the planar body 334. Each of the arms 336a, 336b, 338a, 338b have a first portion 340 adjacent the body 334 that is curved or angled outward from the body 334. The sides of the first portion 340 of the arms 336a, 336b, 338a, 338b taper inward so that a width of the first portion 340 nearest the main body 334 is larger than the width of the first portion 340 away from the main body. The left and right arms 338a, 338b have a second portion 342 that is generally perpendicular to the main body 334 or is slightly angled (for example from about 0 degrees to about 20 degrees) with respect to a transverse axis of the body. Each of the left and right arms 338a, 338b can have a semi-circular cutout on the free bottom edge thereof.

The front and back arms 336a, 336b similarly have a second portion 344 that is generally perpendicular to the main body 334 or is slightly angled (for example from about 0 degrees to about 20 degrees) with respect to a transverse axis of the body 334. The bottom (i.e., free) edge of the second portion 344 is angled in one direction such that one side wall of the second portion 344 is longer than the other side wall of the second portion. The angled bottom edge of the second portion 344 terminates in an outwardly extending tab 348 (i.e., extending away from the main body 334). The outwardly extending tab 348 is configured to flex and grab wires of the cable tray upon twisting into the outer portion 332.

The outer part 332 comprises a generally planar body 350 with left and right downwardly extending arms 352a, 352b. The arms 352a, 352b each have an elongated slot 354 on a central portion thereof. The elongated slot 354 can be used, for example, to insert a screwdriver or other device to aid in rotation of the inner part 331 during installation. Alternatively, the body 334 may contain an opening thereon or an embossed hex configured to engage a screwdriver, Allen wrench, or another suitable tool to aid in rotation. The upper portion of the arms 352a, 352b (i.e., the portion of the arms nearest the planar body 350) have an upwardly extending protrusion 356. The protrusion 356 prevents the disengagement of the inner part 331 when locked into the outer part 332.

The body 350 of the outer part 332 define curved slots 362a, 362b. The curved slots 362a, 362b are generally rounded with a wider portion on the left and right edges by arms 352a, 352b. In this way, the slots 362a, 362b provide sufficient clearance for passage of the tabs 348 of the inner part 331. In this way, the tabs 348 can be inserted in this section and, once the inner part is rotated, the tabs 348 are caught by narrower portion of the slots 362a, 362b, thereby preventing its removal. A lance can be located on an outer edge of each of the slots 362a, 362b. Typically, after installation, the transverse wires of the cable tray are located in the space between the planar body 334 of the inner part 331 and the planar body 350 of the outer part 332. The longitudinal wires are received under the planar body 350 of the outer part 332.

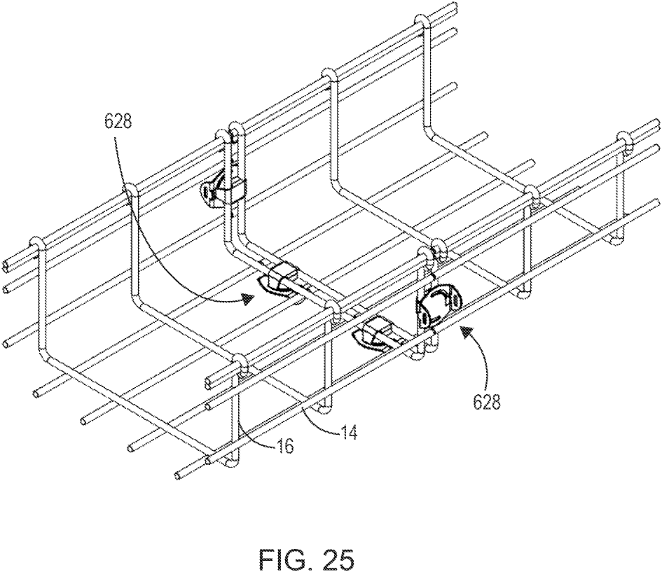

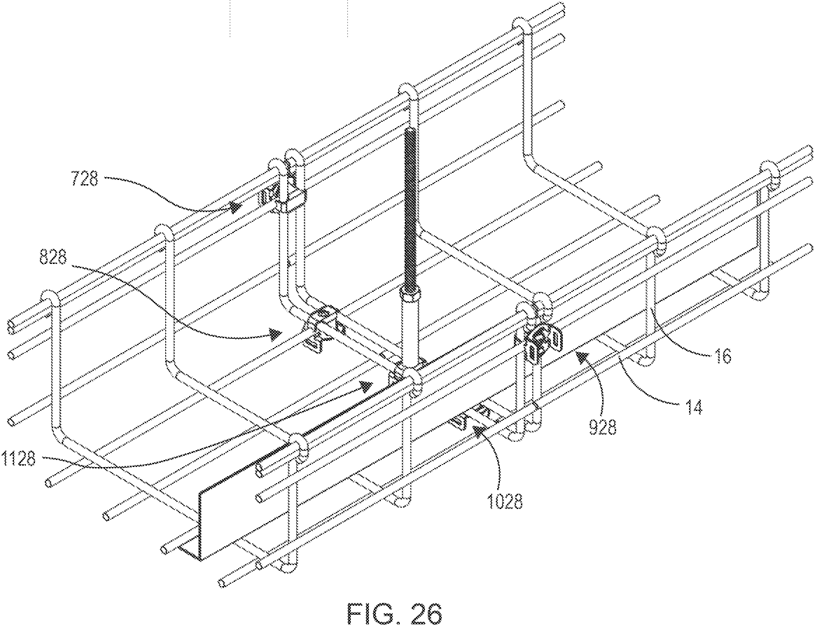

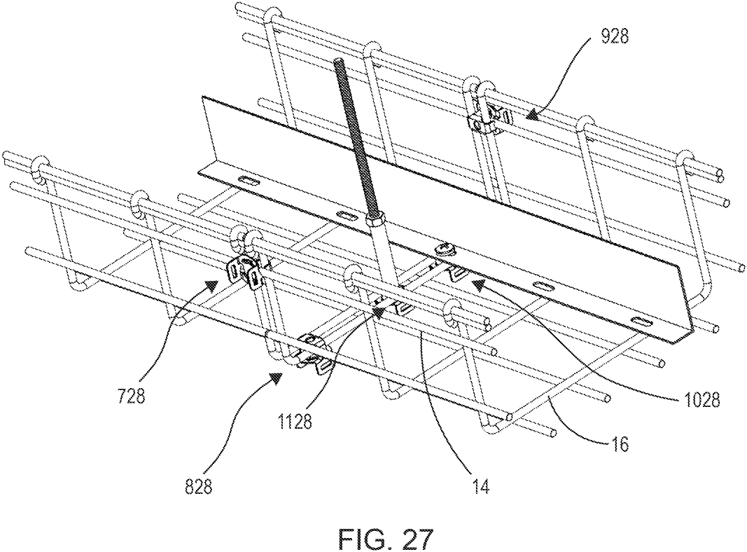

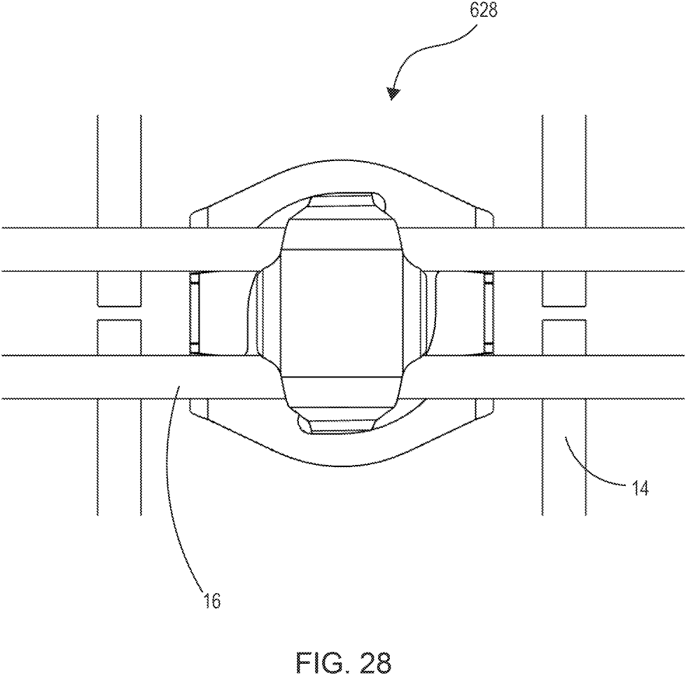

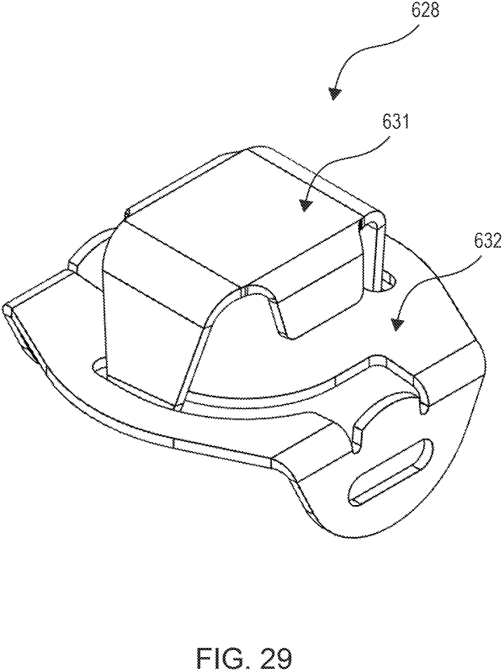

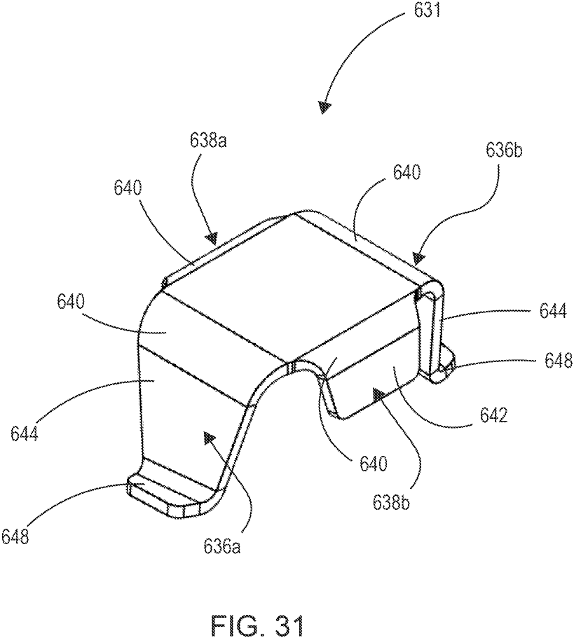

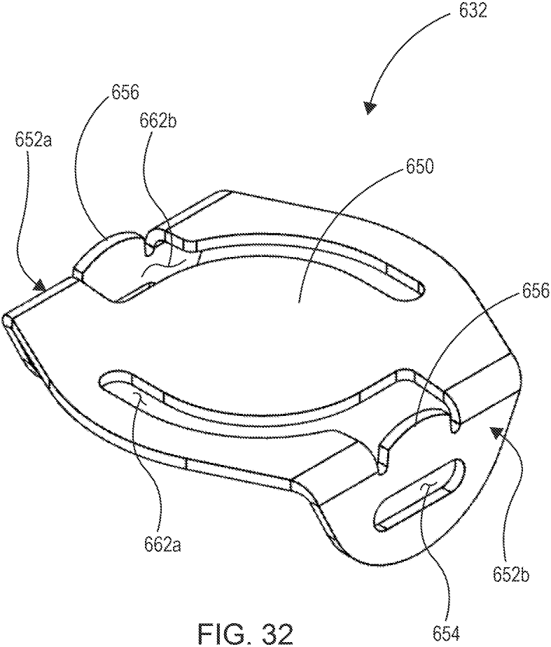

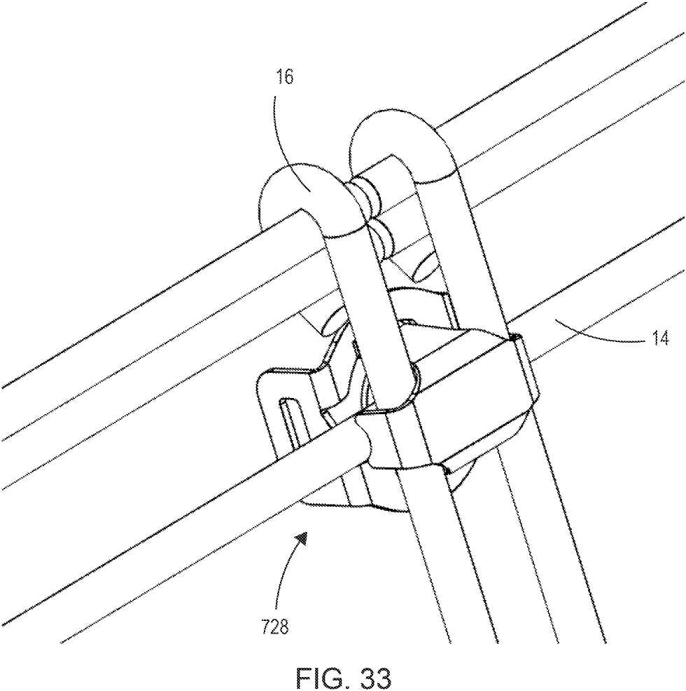

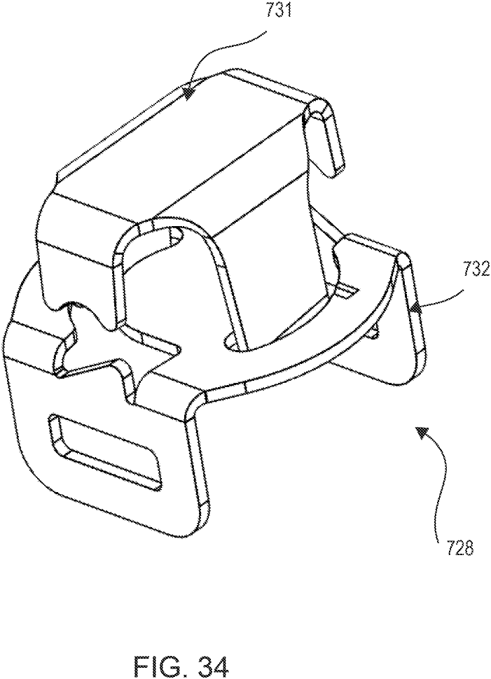

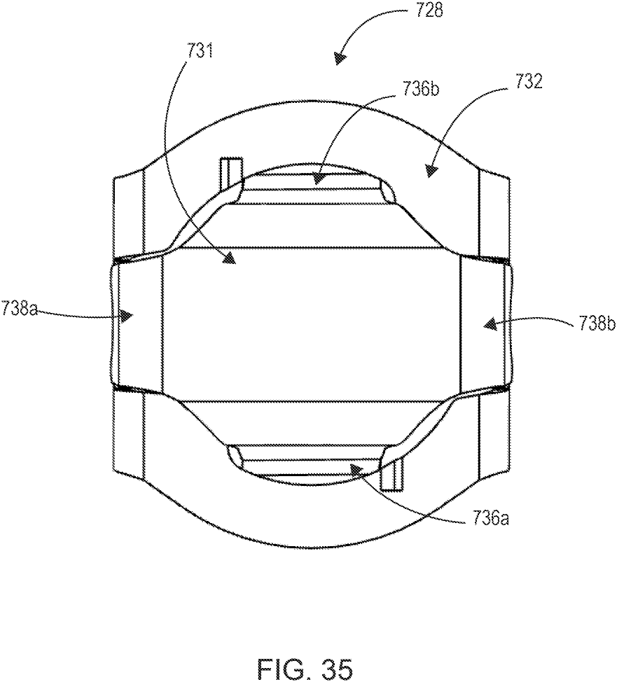

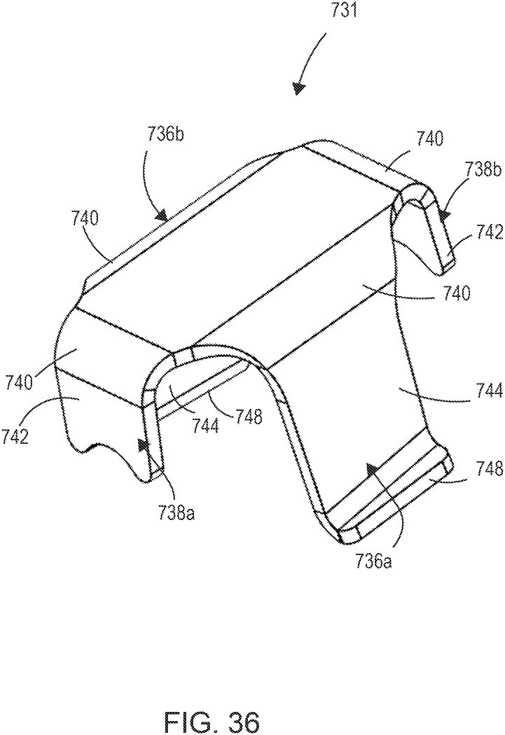

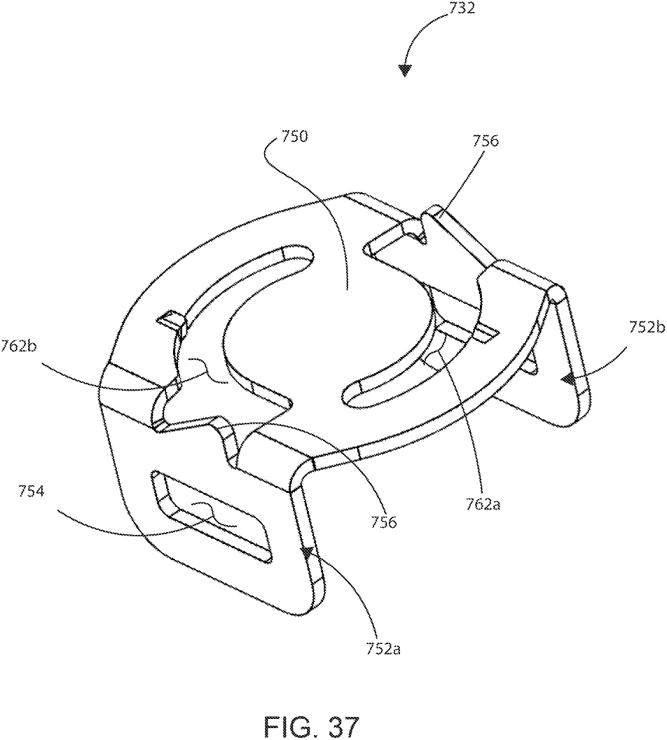

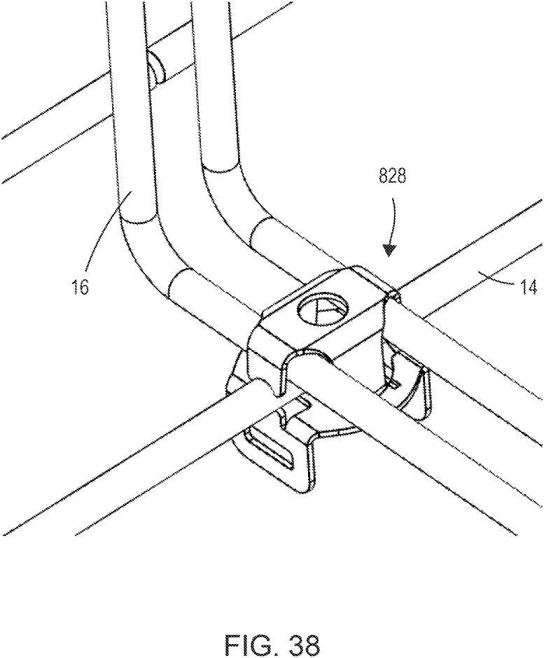

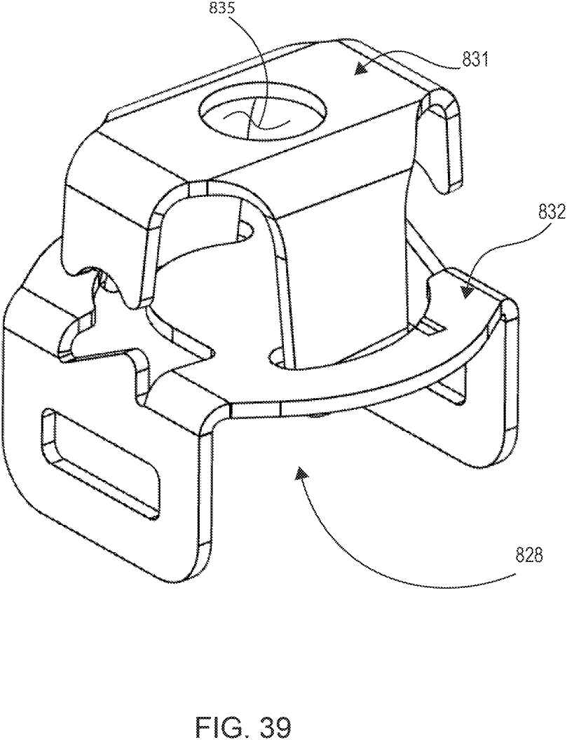

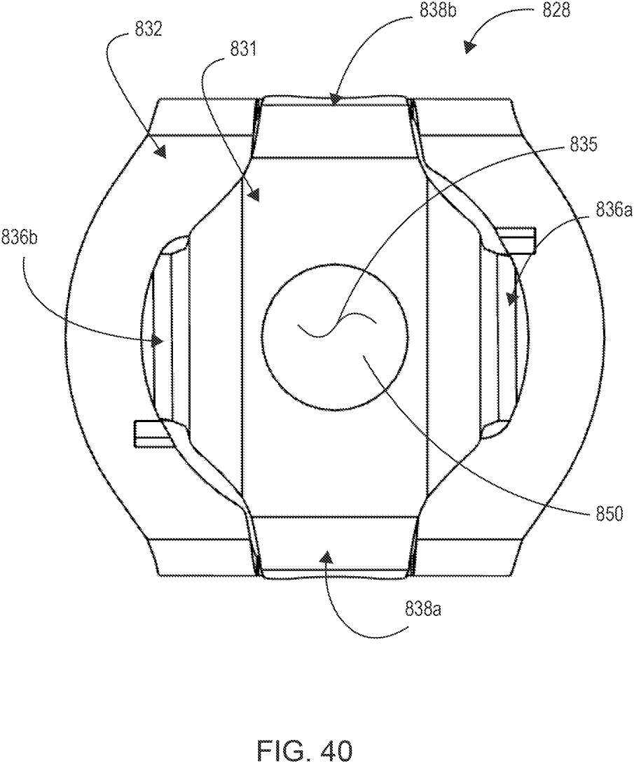

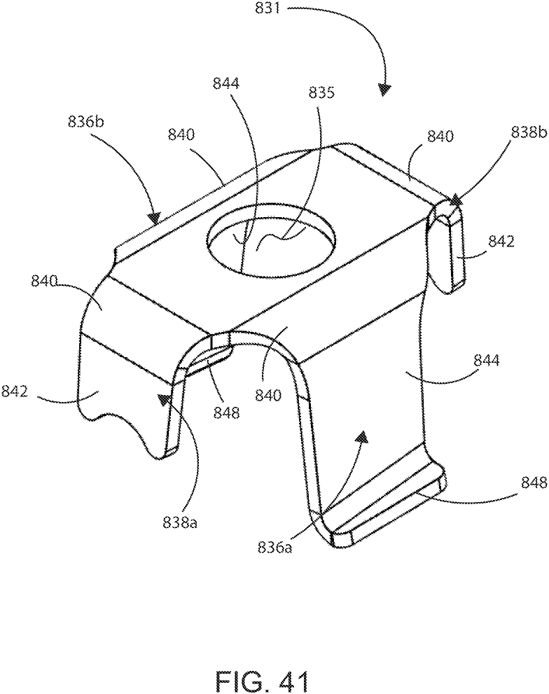

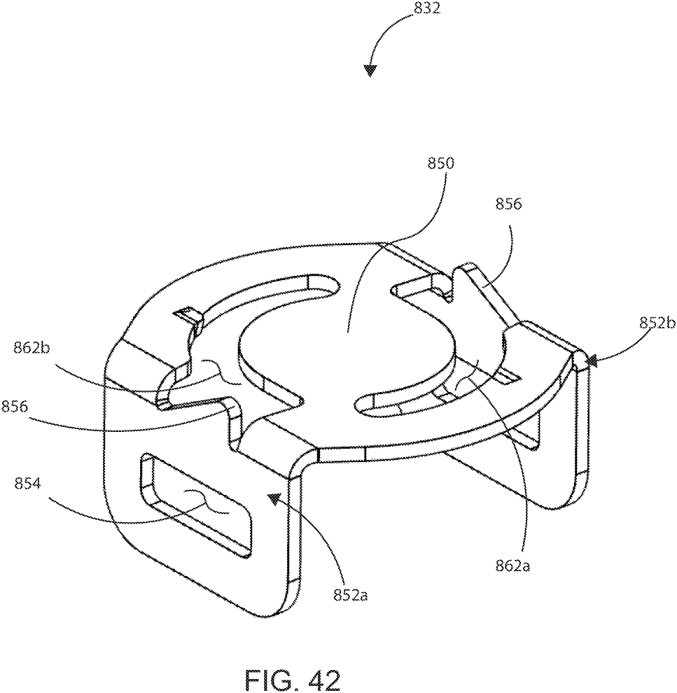

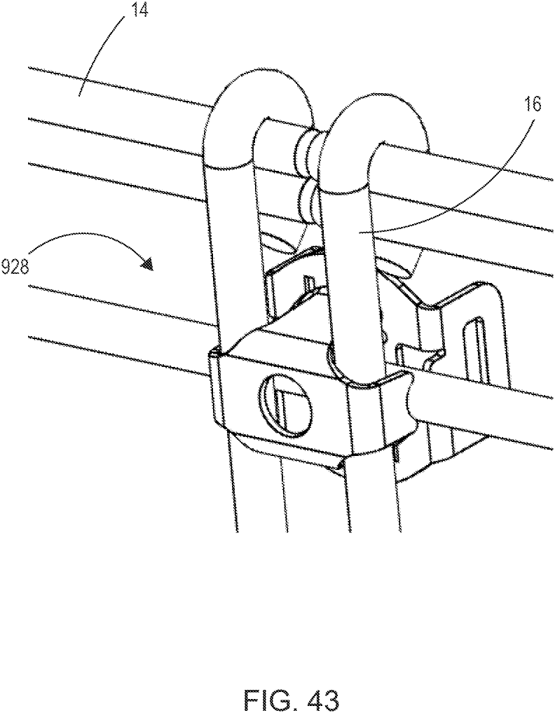

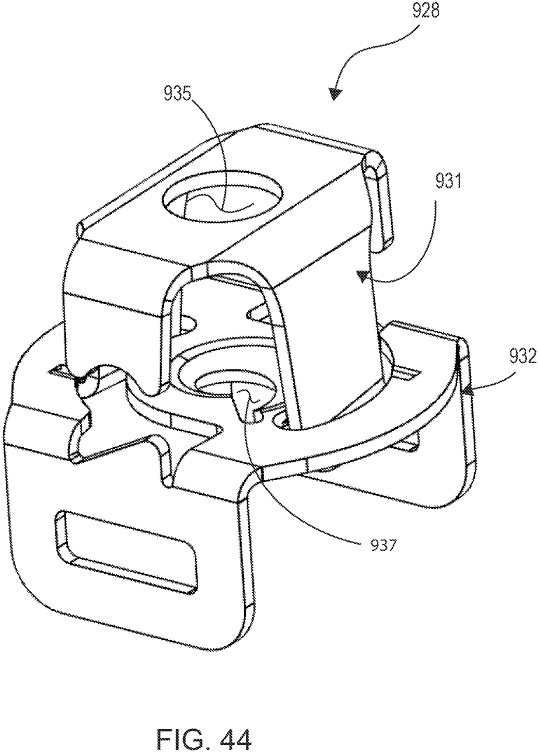

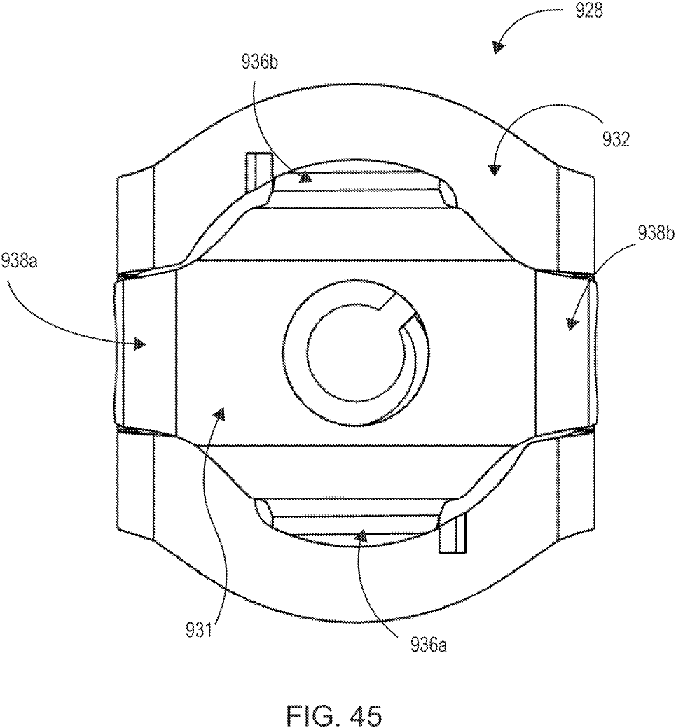

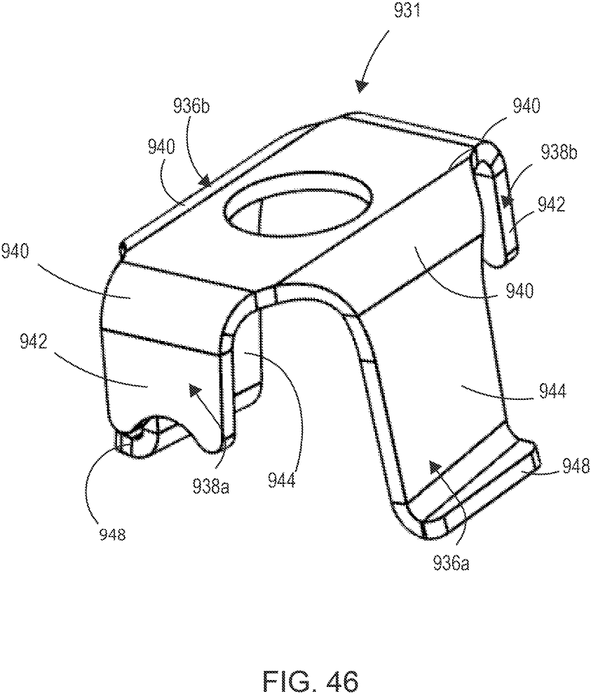

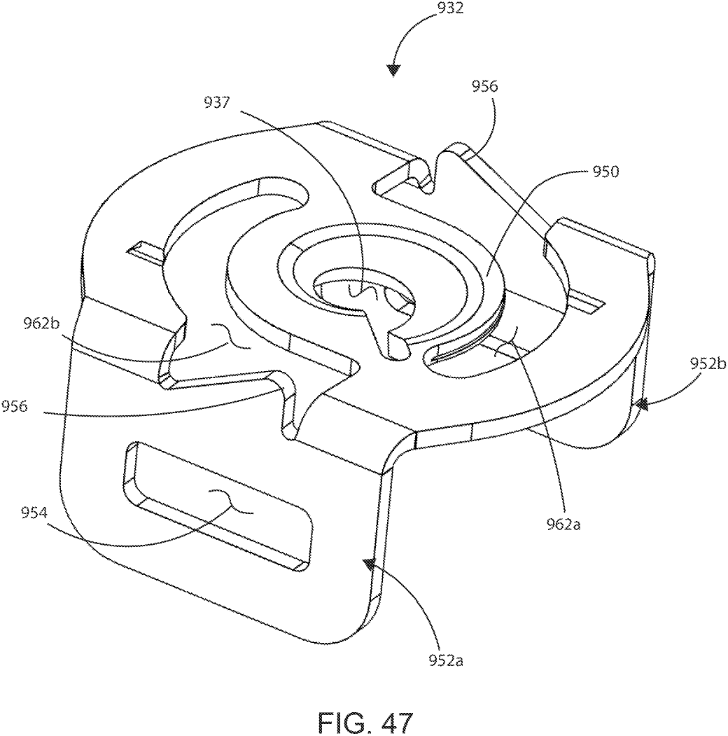

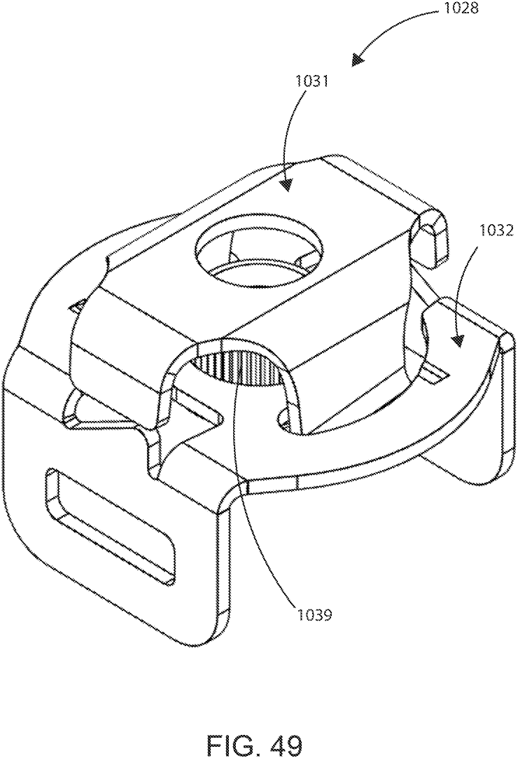

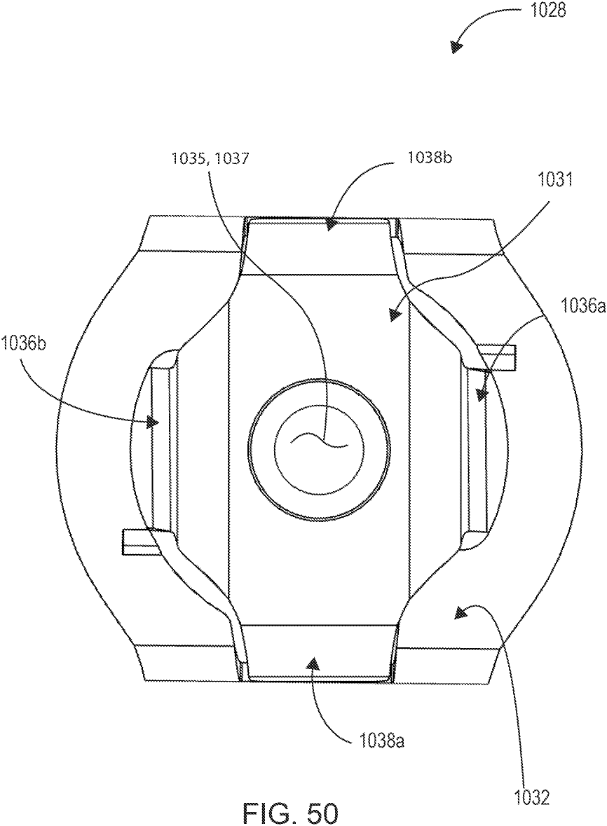

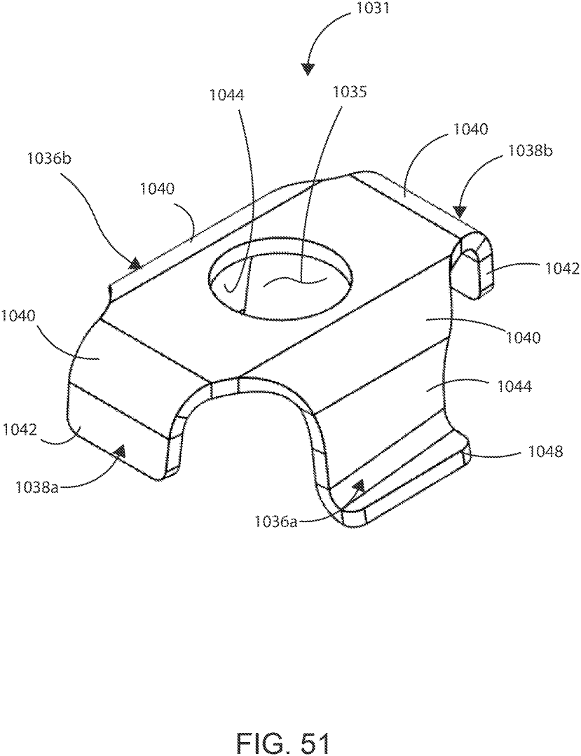

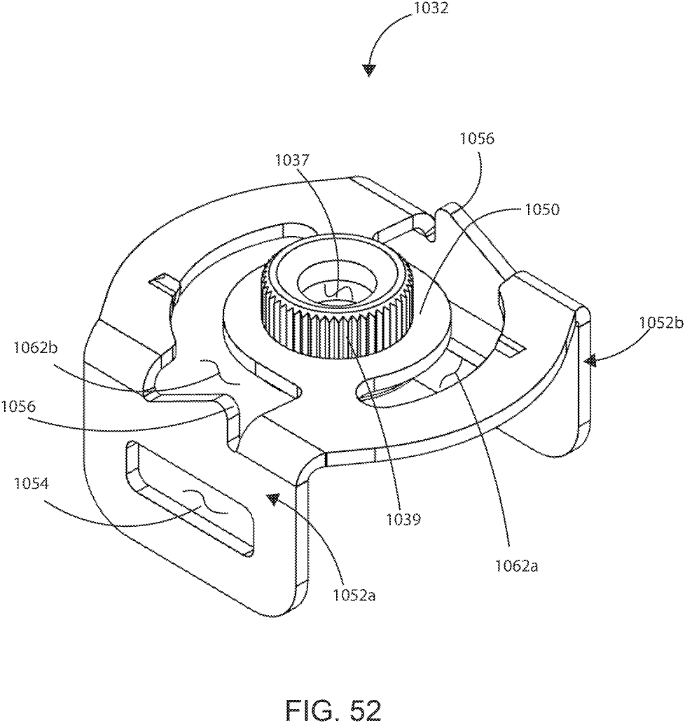

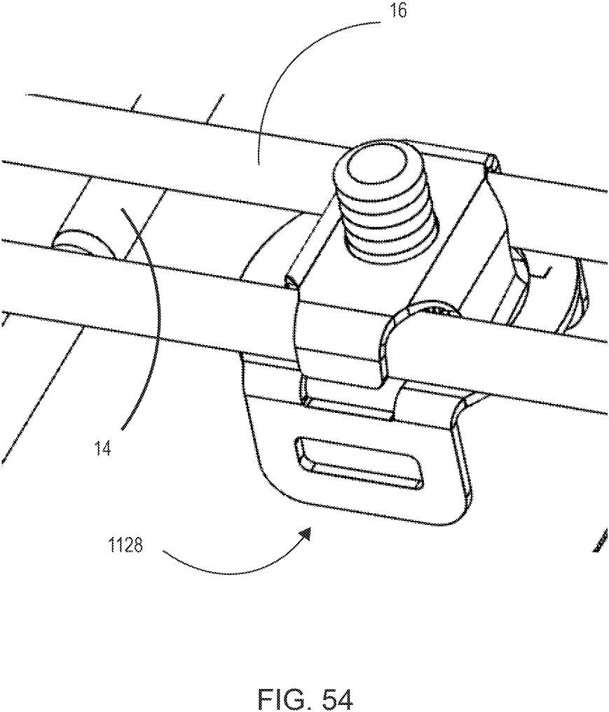

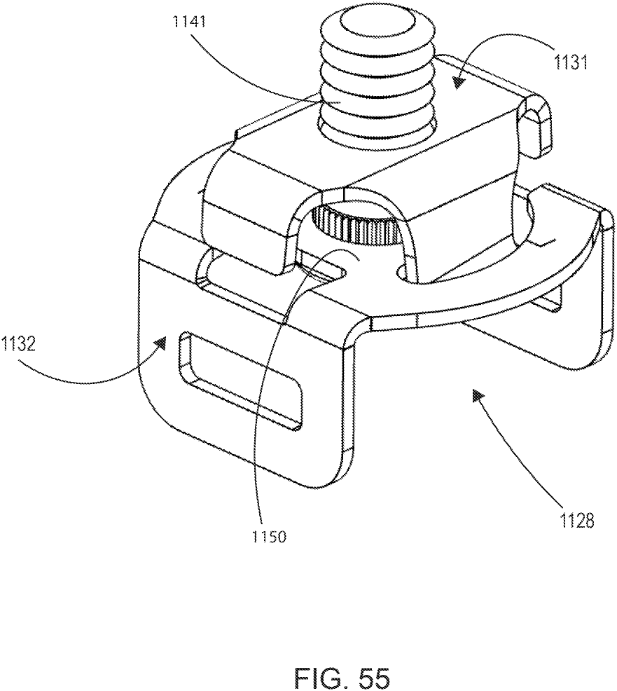

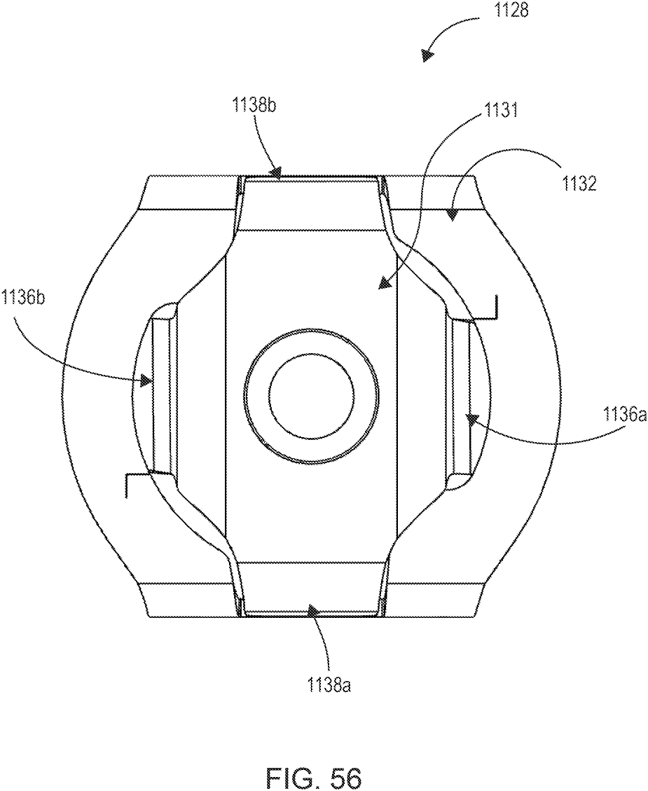

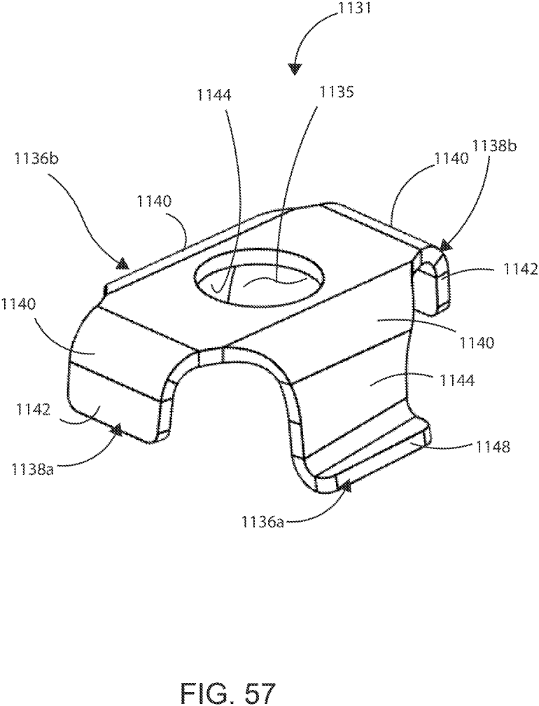

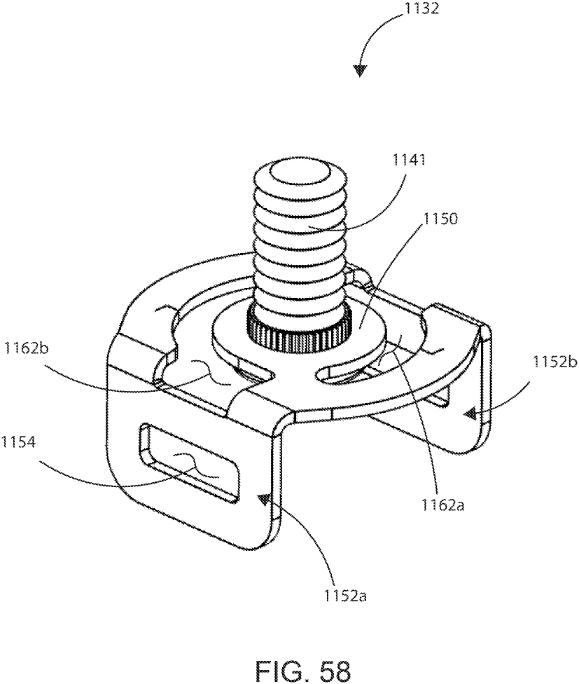

Turning now to FIGS. 25-58 the splice plate assembly 628 (FIG. 25) and splice plate assemblies 728, 828, 928. 1028, 1128 (FIGS. 26-27) are similar to the splice plate assembly 328 that includes inner and outer parts 331, 332 interconnecting after installation.

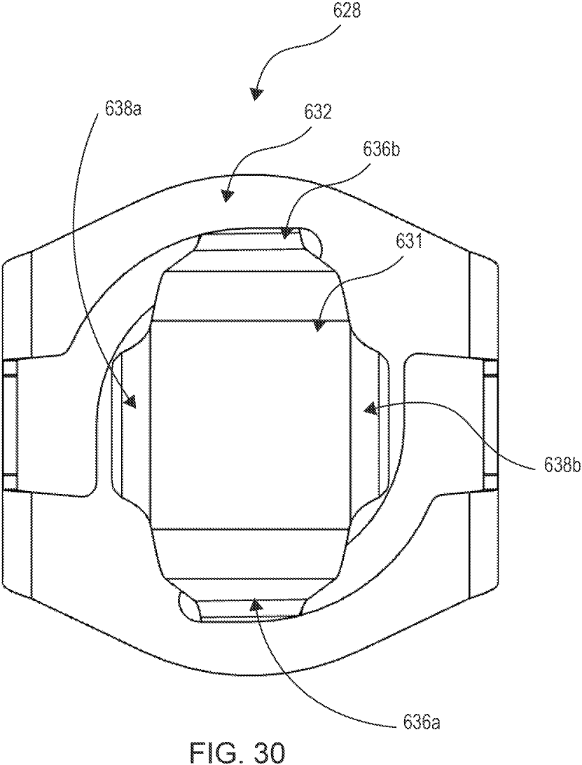

Referring to FIGS. 25 and 28-32, the splice plate assembly 628 is similar to splice plate assembly 328 and similar features are indicated by the same reference numeral plus 300. The splice plate assembly 628 includes a different type of inner part 631. In contrast to inner part 331, the inner part 631 is configure to receive transverse wires 16 of the cable trays without receiving longitudinal wires 14. The inner part 631 comprises a generally planar body 634 with front and back downwardly extending arms 636a, 636b and left and right downwardly extending arms 638a, 638b from each of the edges of the planar body 634. Each of the arms 636a, 636b, 638a, 638b have a first portion 640 adjacent the body 634 that is curved or angled outward from the body 634. The sides of the first portion 640 of the arms 636a, 636b, 638a, 638b taper inward (FIG. 30) so that a width of the first portion 640 nearest the main body 634 is larger than the width of the first portion 640 away from the main body 334. The left and right arms 638a, 638b have a second portion 642 that is generally perpendicular to the main body 634 or is slightly angled (for example from about 0 degrees to about 20 degrees) with respect to a transverse axis of the body. Each of the left and right arms 638a, 638b have a generally straight free bottom edge terminating the second portion 642. The front and back arms 636a, 636b similarly have a second portion 644 that is generally perpendicular to the main body 634 or is slightly angled (for example from about 0 degrees to about 20 degrees) with respect to a transverse axis of the body 634. The bottom (i.e., free) edge of the second portion 644 is angled in one direction such that one side wall of the second portion is longer than the other side wall of the second portion. The angled bottom edge of the second portion 644 terminates in an outwardly extending tab 648 (i.e., extending away from the main body 634). The outwardly extending tab 648 is configured to flex and grab wires of the cable tray upon twisting into the outer portion 632.

The outer part 632 comprises a generally planar body 650 with left and right downwardly extending arms 652a, 652b. The arms 652a, 652b each have an elongated slot 654 on a central portion thereof. The elongated slot 654 can be used, for example, to insert a screwdriver or other device to aid in rotation of the inner part 631 during installation. Alternatively, the body 634 may contain an opening thereon or an embossed hex configured to engage a screwdriver, Allen wrench, or another suitable tool to aid in rotation. The upper portion of the arms 652a, 652b (i.e., the portion of the arms nearest the planar body 650) have an upwardly extending protrusion 656. The protrusion 656 prevents the disengagement of the inner part 631 when locked into the outer part 632. The body 650 of the outer part 632 define curved slots 662a, 662b. The curved slots 662a, 662b are generally rounded with a wider portion on the left and right edges by arms 652a, 652b. In this way, the slots 662a, 662b provide sufficient clearance for passage of the tabs 648 of the inner part 631. In this way, the tabs 648 can be inserted in this section and, once the inner part is rotated, the tabs 648 are caught by narrower portion of the slots 662a, 662b, thereby preventing its removal. A lance can be located on an outer edge of each of the slots 662a, 662b. Typically, after installation, the transverse wires of the cable tray are located in the space between the planar body 634 of the inner part 631 and the planar body 650 of the outer part 632. In particular, a first slot for receiving a transverse wire 16 of a first cable tray is defined by corners between the front downwardly extending arm 636a and the left and right downwardly extending arms 638a, 638b. Further, a second slot for receiving a transverse wire 16 of a second cable tray is defined by corners between the back downwardly extending arm 636b and the left and right downwardly extending arms 638a, 638b.

Referring to FIGS. 26-27 and 33-37, the splice plate assembly 728 is similar to splice plate assembly 628 and similar features are indicated by the same reference numeral plus 100. The splice plate assembly 728 includes a different type of inner part 731 and outer part 732. In contrast to inner part 631, the left and right arms 738a, 738b of the inner part 731 has a semi-circular cutout on the free bottom terminating the second portion 742 defining a slot for receiving a longitudinal wire 14. In contrast to upwardly extending protrusion 656 of the outer part 632, the upwardly extending protrusion 756 is generally triangular shaped.

Referring to FIGS. 26-27 and 38-42, the splice plate assembly 828 is similar to splice plate assembly 728 and similar features are indicated by the same reference numeral plus 100. The splice plate assembly 828 includes a different type of inner part 831. In contrast to inner part 731, the planar body 834 of the inner part 831 defines an opening 835 in a central portion of the planar body. The opening 835 may be used as a fastener opening for insertion of a bolt to aid in installation and modularity.

Referring to FIGS. 26-27 and 43-47, the splice plate assembly 928 is similar to splice plate assembly 828 and similar features are indicated by the same reference numeral plus 100. The splice plate assembly 928 includes a different type of outer part 932. In contrast to the outer part 832, the planar body 950 of the outer part 932 defines an opening 937 in a central portion of the planar body. The opening 937 may be used as a fastener opening for insertion of a bolt to aid in installation and modularity.

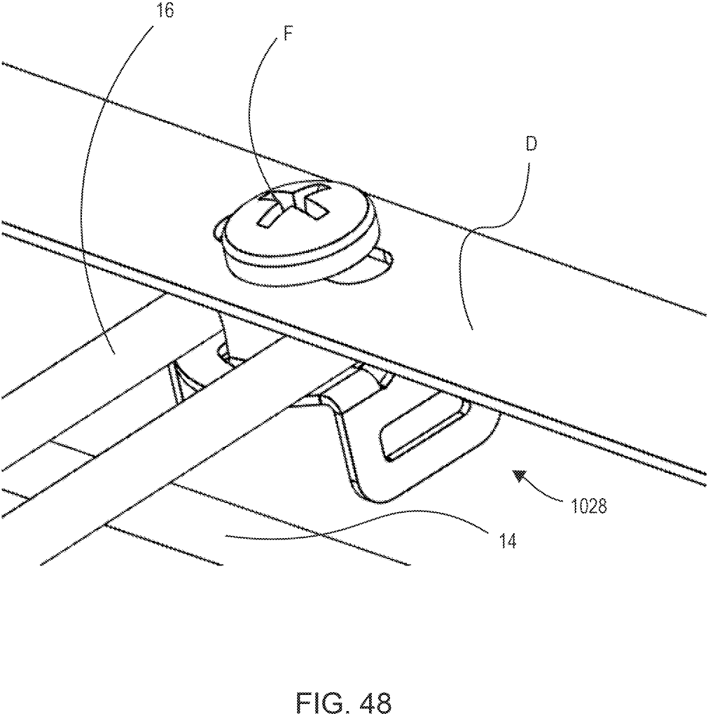

FIGS. 26-27 and 48-52, the splice plate assembly 1028 is similar to splice plate assembly 828 and similar features are indicated by the same reference numeral plus 200. The splice plate assembly 1028 includes a different type of outer part 1032. In contrast to the outer part 832, the planar body 1050 of the outer part 1032 defines an opening 1037 in a central portion of the planar body with a fastener receiving portion 1039 extending around the opening of the outer part. The opening 1037 and fastener receiving portion 1039 may receive and secure a fastener F (FIG. 48) to aid in installation and modularity. For example, the splice plate assembly 1028 and the fastener F may be used to secure a divider D (FIG. 48) to separate sections of the cable trays.

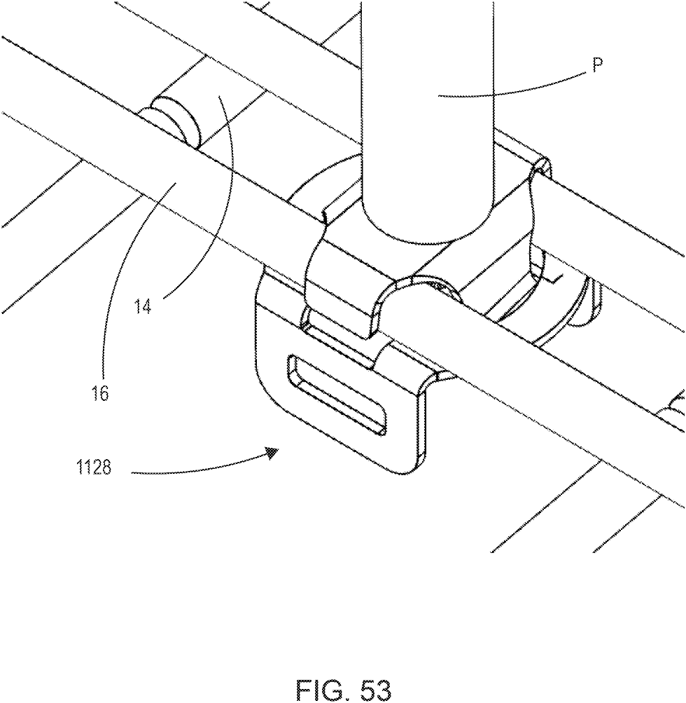

Referring to FIGS. 26-27 and 53-58, the splice plate assembly 1128 is similar to splice plate assembly 1028 and similar features are indicated by the same reference numeral plus 100. The splice plate assembly 1128 includes a different type of outer part 1132. In contrast to outer part 1032, the planar body 1150 of the outer part 1132 includes a fastener protrusion 1141 in a central portion of the planar body that may be used for securing into a divider post P (FIG. 53). Further in contrast to outer part 1032, the upper portion of the arms 1152a, 1152b do not have an upwardly extending protrusion. However, an upwardly extending protrusion may be added to the arms 1152a, 1152b without departing from the scope of the present disclosure.

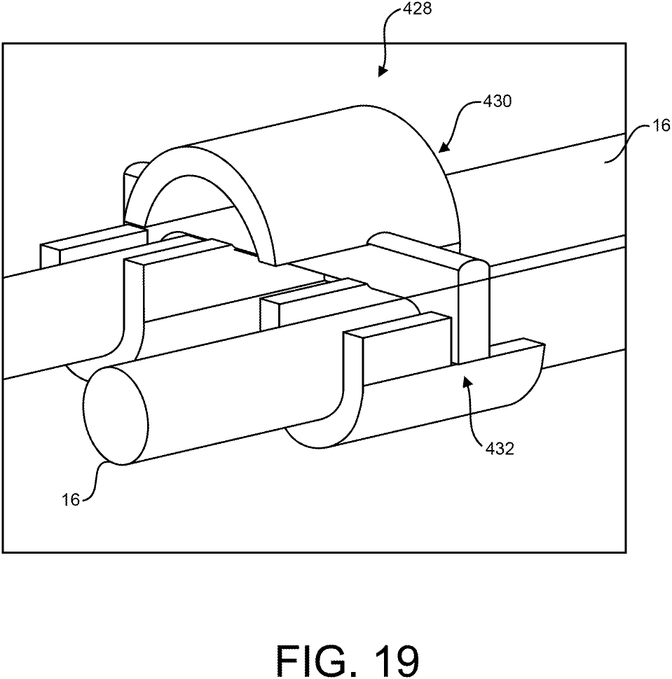

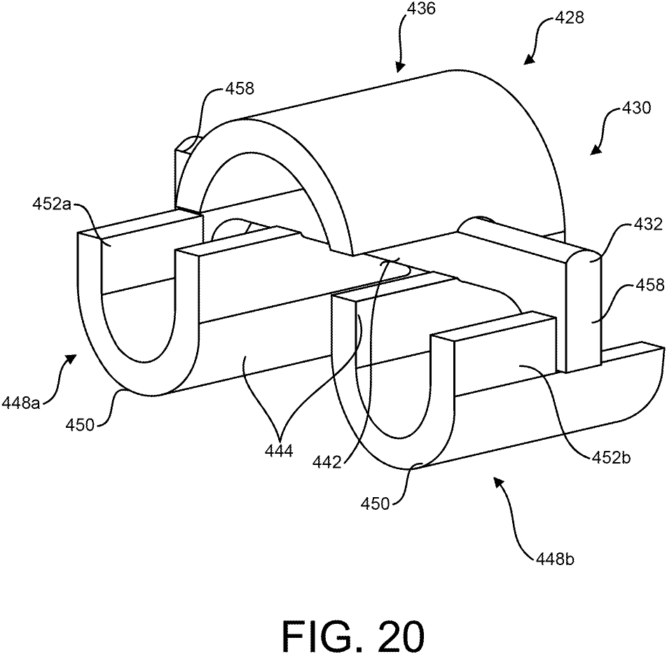

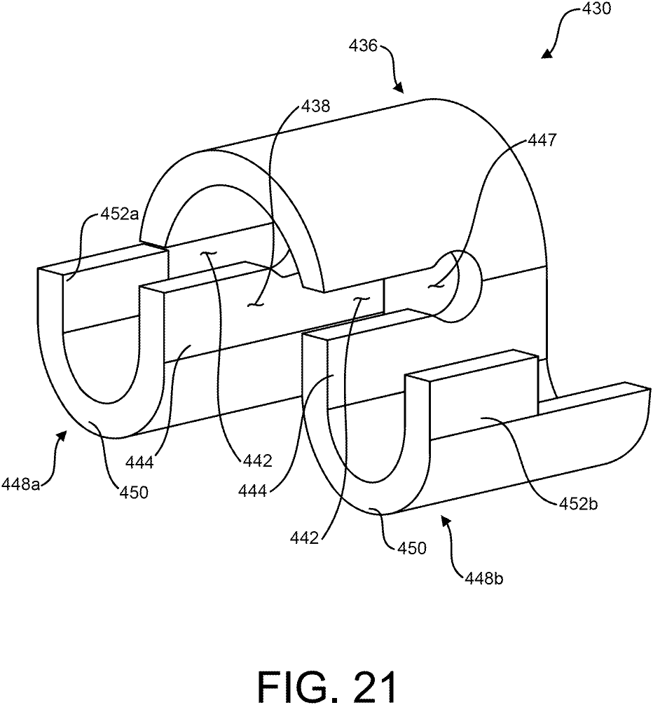

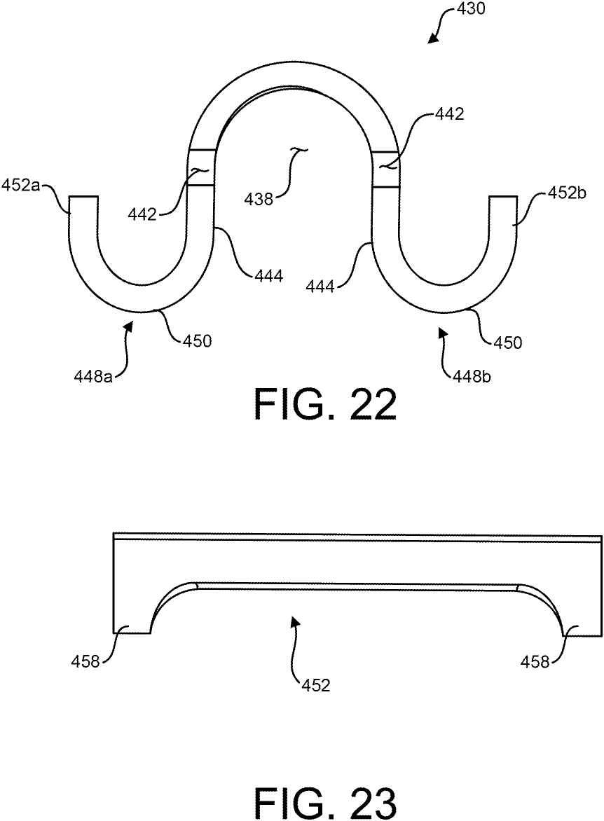

Turning now to FIGS. 19 to 23, another embodiment of the splice plate assembly of the present disclosure is generally indicated at reference numeral 428. The splice plate assembly 428 generally comprises a main body 430 and an interlocking wedge 432. A central section 436 of the main body 430 contains an upper, semi-circular channel section 438. A lower section 440 of the main body 430 continues the channel but with generally planar walls. An elongated slot 442 is defined by an upper portion of the lower section 440 in each of the lower section walls 444. The end of the slot 442 terminates in a circular bulb 447 that has a larger diameter than the width of the slot 442. On either side of the upper channel section 438 are lower channel sections 448a, 448b formed, in part, by the lower sections walls 444, a bottom semi-circular wall 450, and an outer side wall 452a, 452b. The bottom semi-circular walls 450 are generally sized to receive longitudinal wires of the cable tray sections 12. The outer side walls 452a, 452 only extend for a front margin of the splice plate assembly and do not extend beyond the circular bulb 447 of the elongated slot 442.

The interlocking wedge 432 is generally rectangular in shape with downwardly extending arms 458 on either side thereof. The top edge of the wedge 432 is rounded and sized and shaped to be received with the circular bulb 447 with the outer arms extending to and abutting the outer side walls 452a, 452b. The width of the wedge 432 is sized to be received within the elongated slot 442. When rotated about 90 degrees, the wedge 432 is in the locked position with the upper edge fitted within the circular bulbs 447.

Each of the splice plate assemblies described herein allow for the splicing of two wire cable trays in a locked position while maintaining electrical connectivity. These splice plates allow for easy, tool-less installation with a quicker installation time.

Having described the invention in detail, it will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

1. A splice plate for connecting two adjacent wire basket cable trays, the splice plate comprising:
a planar body;
a first pair of opposing side walls and a second pair of opposing side walls, the first and second pairs of opposing side walls extending from the planar body, wherein the first pair of opposing side walls define at least two parallel slots, a first slot of the two parallel slots being configured to engage a first wire of a first cable tray section and a second slot of the two parallel slots being configured to engage a first wire of a second cable tray section parallel to the first wire of a first cable tray, wherein the second pair of opposing side walls define at least one slot, a side wall of one of the second pair of opposing side walls being configured to engage a second wire of the first cable tray section transverse to the first wire of the first cable tray section. and a side wall of the other of the second pair of opposing side walls being configured to engage a second wire of the second cable tray section aligned with the second wire of the first cable tray and transverse to the first wire of the second cable tray section; and
a pair of tabs extending toward a central axis of the planar body, one of said pair of the tabs configured to engage the first wire of the first cable tray section, and the other of said pair of tabs configured to engage the first wire of the second cable tray section.

2. The splice plate of claim 1, wherein the first pair of opposing side walls extend from the planar body on front and back portions and the second pair of opposing side walls extend from the planar body on left and right portions, wherein the first wires of the first and second cable tray section are longitudinal wires and the second wires of the first and second cable tray section are transverse wires.

3. The splice plate of claim 1, wherein the first pair of opposing side walls extend from the planar body on left and right portions and the second pair of opposing side walls extend from the planar body on front and back portions, wherein the first wires of the first and second cable tray section are transverse wires and the second wires of the first and second cable tray section are longitudinal wires.

4. The splice plate of claim 1, wherein the first pair of opposing side walls extend generally perpendicular from the planar body and the second pair of opposing side walls extend from the planar body at an angle from about 20 degrees to about 80 degrees.

5. The splice plate of claim 1, wherein the first and second pairs of opposing side walls extend generally perpendicular from the planar body.

6. The splice plate of claim 1, wherein each side wall of the first pair of opposing side walls comprises at least one locking tab extending inward towards the other of the first pair of opposing side walls.

7. The splice plate of claim 1, further comprising locking tabs extending between adjacent side walls of the first and second pairs of opposing side walls.

8. The splice plate of claim 1, further comprising at least two arms extending from the planar body at a downward angle relative to a longitudinal plane of the planar body, wherein the at least two tabs extend from respective ones of the at least two arms, and wherein the tabs extend at an upward angle relative to the longitudinal plane of the planar body.

9. The splice plate of claim 1, further comprising two arms, extending from the second pair of side walls, wherein a first arm extends from a first of the second pair of opposing side walls, and a second arm extends from a second of the second pair of opposing side walls, wherein the at least two tabs extend from respective ones of the two arms, and wherein the two tabs are inward-extending.

10. The splice plate of claim 1, wherein the planar body defines an opening in a central portion of the planar body and comprises ribs extending from an adjacent portion of the planar body to an elevated height.

11. A splice plate assembly for connecting two adjacent wire basket cable trays, the splice plate assembly comprising:
an inner part comprising:
a planar body;
a side wall extending transversely from the planar body, the side wall terminating in an outwardly extending tab; and
an outer part comprising:
a planar body;
first and second side walls extending downward from the planar body
away from the inner part
at least two slots being defined by the planar body, each of the slots having a wider portion configured to allow insertion of the side wall of the inner part, and a narrower portion configured to lock the inner part into the outer part by preventing passage of the tab of the side wall of the inner part.

12. The splice plate assembly of claim 11, wherein first and second side walls of the outer part each have an upward extending protrusion.

13. The splice plate assembly of claim 11, wherein the inner part comprises four side walls, wherein adjacent side walls of the four side walls define slots extending through the inner part and configured to receive a wire from the cable tray.

14. The splice plate of claim 11, wherein the side wall of the inner part is a first side wall of a pair of first opposing side walls, the inner part comprising and second pair of opposing side walls, the first pair of opposing side walls each terminating in an outwardly extending tab, the second pair of opposing side walls each terminating with a concave end, wherein each concave end is configured to receive a wire of a separate cable tray.

15. The splice plate of claim 11, wherein adjacent walls of the first and second pairs of opposing side walls define at least two slots, wherein the first slot extends along a first side wall of the second pair of opposing side walls and is configured to receive a first wire from a first cable tray, wherein the second slot extends along a second side wall of the second pair of opposing side walls and is configured to receive a first wire from a second cable tray.

16. The splice plate of claim 11, wherein the inner part and the outer part define a space between the planar bodies of the inner and outer parts configured to receive transverse wires of adjacent cable trays.

17. The splice plate of claim 11, wherein the planar body of the inner part defines an opening in a central portion of the planar body of the inner part, the opening being configured to aid in installation and modularity.

18. The splice plate of claim 17, wherein the planar body of the outer part defines an opening in a central portion of the planar body of the outer part, wherein the openings in the central portions of the planar bodies align when the inner and outer parts are coupled.

19. The splice plate of claim 17, wherein the planar body of the outer part comprises a central protrusion in a central portion of the planar body of the outer part, wherein the central protrusion extends through the opening in the central portion of the planar body of the inner part when the inner and outer parts are coupled.

20. The splice plate of claim 11, wherein the narrow portion of the outer body slots has a curved-shape.

21. A splice plate assembly for connecting two adjacent wire basket cable trays, the splice plate assembly comprising:
a planar body;
an inboard wall downwardly extending from the planar body; and
an outboard wall downwardly extending from the planar body, wherein the outboard wall comprises two extension tabs and a central tab between the two extension tabs and spaced apart by a slot, wherein each slot is configured to receive a separate transverse wire of adjacent cable tray sections, wherein the extension tabs and central tab each comprise a catch being configured to receive at least one longitudinal wire.

22. A splice plate assembly for connecting two adjacent wire basket cable trays, the splice plate assembly comprising:
a main body comprising an upper channel section and at least one lower channel section extending from the upper channel section, wherein a transition portion from upper channel section and lower channel section defines an elongated slot; and
an interlocking wedge received in the elongated slot and configured to rotate in the elongated slot to a locked position.
